(19) United States
(12) Patent Application Publication
(10) Pub. No.: US 2014/0095148 A1
(43) Pub. Date: Apr. 3, 2014

(54) EMOTION IDENTIFICATION SYSTEM AND METHOD

(71) Applicant: Kanjoya, Inc., San Francisco, CA (US)

(72) Inventors: Armen Berjikly, San Francisco, CA (US); Moritz Sudhof, Mountain View, CA (US); Kumar Garapaty, San Francisco, CA (US); Neil Sheth, San Francisco, CA (US)

(21) Appl. No.: 13/834,633

(22) Filed: Mar. 15, 2013

Related U.S. Application Data
(60) Provisional application No. 61/744,840, filed on Oct. 3, 2012.

(51) Int. Cl. G06F 17/28

(52) U.S. Cl. CPC G06F 17/28
USPC 704/9

(57) ABSTRACT

A system and method for identifying emotion in text that connotes authentic human expression, and training an engine that produces emotional analysis at various levels of granularity and numerical distribution across a set of emotions at each level of granularity. The method may include determining similarity between textual data and an emotion, and classifying emotions as similar emotions.

### CROSS REFERENCE TO RELATED APPLICATIONS

This application claims the benefit of and the priority of U.S. Provisional Application No. 61/744,840 filed on Oct. 3, 2012, the entire contents of which are hereby incorporated by reference herein.

### FIELD OF THE INVENTION

The present invention generally relates to a system and method for identifying emotion in text that connotes authentic human expression, and training an engine that produces emotional analysis at various levels of granularity and numerical distribution across a set of emotions at each level of granularity.

### BACKGROUND OF THE INVENTION

Methods have been developed that model emotion, analyze emotional speech, and sense physical indications of emotion including changes in brain signals, heart rate, perspiration, and facial expression.

A method of analyzing emotion in text includes sentiment analysis, which may involve classifying documents into emotive categories, such as positive or negative. Conventional sentiment analysis has been used to track public opinion, employee attitude, and customer satisfaction with products of the corporations.

However, such sentiment analysis methods are limited and rely heavily on manual interpretation of the text, including having a searcher physically review the text, and determine whether the document is generally positive or negative. Other sentiment analysis systems simply count and sum key words in a document, such as “pleased” or “upset,” to then calculate if the entire document is more “pleased” than “upset,” for example. Other sentiment analysis systems analyze text, yet apply only limited databases to determine whether the document is generally positive or negative.

### SUMMARY OF THE INVENTION

The present disclosure addresses the above-described problems, in part, by providing a method and system of identifying emotions in text based on the underlying emotional content of the text.

In certain embodiments, the disclosure contemplates a method, apparatus, and non-transitory computer readable medium for determining similarity between textual data and an emotion. The method includes a step of receiving first textual data authored by a first individual. The method further includes a step of receiving a first tag for the first textual data that is associated with at least one emotion and associates the first textual data with the at least one emotion, the first tag being set by the first individual. The method further includes a step of allowing a second individual to retrieve the first textual data from an online forum system to view the first textual data. The method further includes a step of processing the first textual data to produce a first data indicator defining emotional content of the first textual data. The method further includes a step of receiving second textual data from the second individual. The method further includes a step of processing the second textual data to produce a second data indicator defining emotional content of the second textual data. The method further includes a step of inputting the first data indicator into an emotion similarity model and the second data indicator into the emotion similarity model to determine a similarity between the second textual data and the at least one emotion associated with the first tag.

In certain embodiments, the disclosure contemplates a method, apparatus, and non-transitory computer readable medium for classifying emotions as similar emotions. The method includes a step of receiving first textual data. The method further includes a step of receiving a first tag for the first textual data that is associated with at least one emotion and associates the first textual data with the at least one emotion of the first tag. The method further includes a step of processing the first textual data to produce a first data indicator defining emotional content of the first textual data. The method further includes a step of receiving second textual data. The method further includes a step of receiving a second tag for the second textual data that is associated with at least one emotion and associates the second textual data with the at least one emotion of the second tag. The method further includes a step of processing the second textual data to produce a second data indicator defining emotional content of the second textual data. The method further includes a step of comparing the first data indicator with the second data indicator to determine a similarity between the first data indicator and the second data indicator. The method further includes a step of determining whether to classify the at least one emotion of the first tag and the at least one emotion of the second tag as a similar emotion group, based on the similarity between the first data indicator and the second data indicator. The method further includes a step of classifying the at least one emotion of the first tag and the at least one emotion of the second tag as the similar emotion group.

In certain embodiments, the disclosure contemplates a method, apparatus, and non-transitory computer readable medium for classifying textual data as emotional textual data or non-emotional textual data. The method includes a step of providing a database of data indicators that each define emotional content of textual data. The method further includes a step of processing the first textual data to produce a first data indicator defining emotional content of the first textual data. The method further includes a step of inputting the first data indicator into an emotion similarity model and the data indicators of the database into the emotion similarity model to determine at least one similarity between the first data indicator and the data indicators of the database. The method further includes a step of classifying the first textual data as emotional textual data or non-emotional textual data based on the at least one similarity.

In certain embodiments, the disclosure contemplates a method, apparatus, and non-transitory computer readable medium for producing a chart of data transmission referenced against time. The method includes a step of providing a database of data indicators that each define emotional content of textual data. The method further includes a step of receiving a plurality of textual data transmissions sent by at least one individual during a span of time. The method further includes a step of processing the plurality of textual data transmissions to produce at least one data indicator defining emotional content of the plurality of textual data transmissions. The method further includes a step of inputting the at least one data indicator of the plurality of textual data transmissions into an emotion similarity model and the data indicators of the database into the emotion similarity model to determine at least one similarity between the at least one data indicator of the plurality of textual data transmissions and the data indicators of the database. The method further includes a step of producing a chart displaying at least one value corresponding to the at least one similarity referenced against at least a portion of the span of time.

In certain embodiments, the disclosure contemplates a method, apparatus, and non-transitory computer readable medium for comparing filtering data transmissions to a database. The method includes a step of providing a database of data indicators that each define emotional content of textual data. The method further includes a step of receiving a plurality of textual data transmissions sent by at least one individual. The method further includes a step of filtering the plurality of textual data transmissions to produce a subset of the plurality of textual data transmissions based on whether words of the plurality of textual data transmissions contain at least one specified word. The method further includes a step of processing the subset of the plurality of textual data transmissions to produce at least one data indicator defining emotional content of the subset of the plurality of textual data transmissions. The method further includes a step of inputting the at least one data indicator of the subset of the plurality of textual data transmissions into an emotion similarity model and the data indicators of the database into the emotion similarity model to determine at least one similarity between the at least one data indicator of the subset of the plurality of textual data transmissions and the data indicators of textual data of the database.

In certain embodiments, the disclosure contemplates a method, apparatus, and non-transitory computer readable medium for determining duration of an emotional state. The method includes a step of receiving first textual data authored by a first individual. The method further includes a step of receiving a first tag for the first textual data that is associated with at least one emotion and associates the first textual data with the at least one emotion of the first tag, the first tag being set by the first individual. The method further includes a step of receiving second textual data authored by the first individual. The method further includes a step of receiving a second tag for the second textual data that is associated with at least one emotion and associates the second textual data with the at least one emotion of the second tag, the second tag being set by the first individual and being associated with a different at least one emotion than the first tag. The method further includes a step of determining a duration between when the first textual data is received and the second textual data is received to determine a duration of the at least one emotion associated with the first tag.

In certain embodiments, the disclosure contemplates a method, apparatus, and non-transitory computer readable medium for selecting a database based on a demographic class of an author. The method includes a step of providing a first database of data indicators that each define emotional content of textual data and are associated with a first demographic class. The method further includes a step of providing a second database of data indicators that each define emotional content of textual data and are associated with a second demographic class. The method further includes a step of receiving first textual data authored by a first individual who is associated with the first demographic class. The method further includes a step of processing the first textual data to produce a first data indicator defining emotional content of the first textual data. The method further includes a step of receiving second textual data authored by a second individual who is associated with the second demographic class. The method further includes a step of processing the second textual data to produce a second data indicator defining emotional content of the second textual data. The method further includes a step of determining whether to input the first data indicator into a first emotion similarity model that utilizes the data indicators of the first database, or into a second emotion similarity model that utilizes the data indicators of the second database, based on whether the first individual is associated with the first demographic class or the second demographic class. The method further includes a step of inputting the first data indicator into the first emotion similarity model to determine a similarity between the first textual data and the data indicators of the first database. The method further includes a step of inputting the second data indicator into the second emotion similarity model to determine a similarity between the second textual data and the data indicators of the second database.

### BRIEF DESCRIPTION OF THE DRAWINGS

Features and advantages of the present invention will become appreciated as the same become better understood with reference to the specification, claims, and appended drawings wherein:

FIG. 1 illustrates a representation of a system for implementing a method of the disclosure, according to one embodiment of the present disclosure;

FIG. 2 illustrates a webpage for use with the present system and method, according to one embodiment of the present disclosure;

FIG. 3 illustrates a representation of a process for use with the present system and method, according to one embodiment of the present disclosure;

FIG. 4 illustrates a representation of a process for use with the present system and method, according to one embodiment of the present disclosure;

FIG. 5 illustrates a representation of a process for use with the present system and method, according to one embodiment of the present disclosure;

FIG. 6A illustrates a representation of a process for use with the present system and method, according to one embodiment of the present disclosure;

FIG. 6B illustrates a matrix for use with the present system and method, according to one embodiment of the present disclosure;

FIG. 6C illustrates a matrix for use with the present system and method, according to one embodiment of the present disclosure;

FIG. 7A illustrates a representation of a process for use with the present system and method, according to one embodiment of the present disclosure;

FIG. 7B illustrates a matrix for use with the present system and method, according to one embodiment of the present disclosure;

FIG. 7C illustrates a matrix for use with the present system and method, according to one embodiment of the present disclosure;

FIG. 8 illustrates a representation of a process for use with the present system and method, according to one embodiment of the present disclosure;

FIG. 9 illustrates a representation of a process for use with the present system and method, according to one embodiment of the present disclosure;

FIG. 10 illustrates a representation of a process for use with the present system and method, according to one embodiment of the present disclosure;

FIG. 11 illustrates a representation of a process for use with the present system and method, according to one embodiment of the present disclosure;

FIG. 12 illustrates a representation of a chart of emotions for use with the present system and method, according to one embodiment of the present disclosure;

FIG. 13 illustrates a representation of a process for use with the present system and method, according to one embodiment of the present disclosure;

FIG. 14A illustrates a representation of a process for use with the present system and method, according to one embodiment of the present disclosure;

FIG. 14B illustrates a representation of a process for use with the present system and method, according to one embodiment of the present disclosure;

FIG. 15 illustrates a representation of a system for implementing a method of the disclosure, according to one embodiment of the present disclosure;

FIG. 16 illustrates a report for use with the present system and method, according to one embodiment of the present disclosure;

FIG. 17 illustrates a report for use with the present system and method, according to one embodiment of the present disclosure;

FIG. 18 illustrates a representation of a process for use with the present system and method, according to one embodiment of the present disclosure;

FIG. 19 illustrates a representation of a process for use with the present system and method, according to one embodiment of the present disclosure; and

FIG. 20 illustrates a representation of a process for use with the present system and method, according to one embodiment of the present disclosure.

### DETAILED DESCRIPTION OF THE PREFERRED EMBODIMENTS

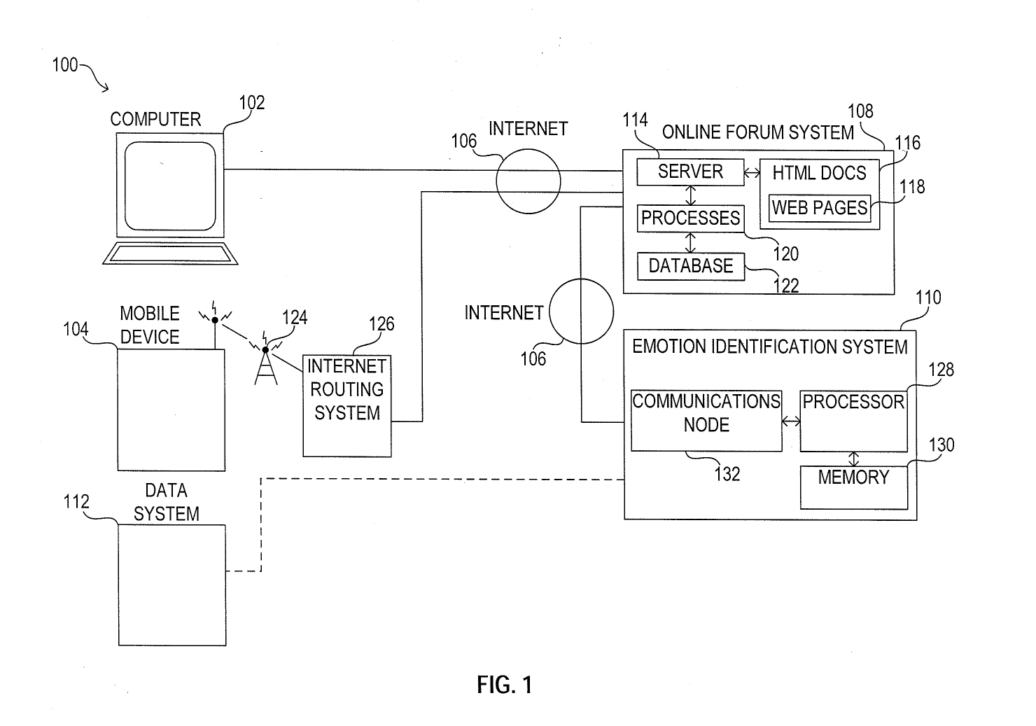

FIG. 1 illustrates an embodiment of a system 100 for implementing methods of the present disclosure. The system 100 includes data input devices including a computer 102 and a mobile device 104 which may communicate through the internet 106 with an online forum system 108.

The online forum system 108 may communicate with an emotion identification system 110. A data system 112 may supply data to the emotion identification system 110.

The online forum system 108 may include a website stored on a server 114. The website may include html documents 116 in the form of webpages 118 accessible on the server 114. The online forum system 108 may include processes 120 that operate the functions of the website, and a database 122 that stores information for use with the website, and produced on the website.

The online forum system 108 allows users to share information with each other. Such information may include textual data that conveys emotions. The textual data includes text that a human may read in a language that is spoken, which does not include computer code, for example. The textual data may comprise a narrative, or a general statement, a query, exclamation, or the like.

Users may utilize a computer 102 or mobile device 104 to access the online forum system 108. The mobile device 104 may utilize a wireless communications node 124, for example, a cell tower, and an internet routing system 126 to access the online forum system 108. The computer 102 may access the online forum system 108 through appropriate hardware, for example, a modem or other communication device. The computer 102 or mobile device 104 may utilize a web browser to access the online forum system 108. Multiple computers 102 or mobile devices 104 may access the online forum system 108 at one time.

Users of the online forum system 108 may be members of the online forum system 108. The users may have a username and password, or other log-in information. The online forum system 108 may store demographic information about the users, including age, sex, and geographic location, including a geographic location of the user's residence. The processes 120 of the online forum system 108 may allow for log-in of the users to the online forum system 108. The database 122 may store the user log-in information and demographic information.

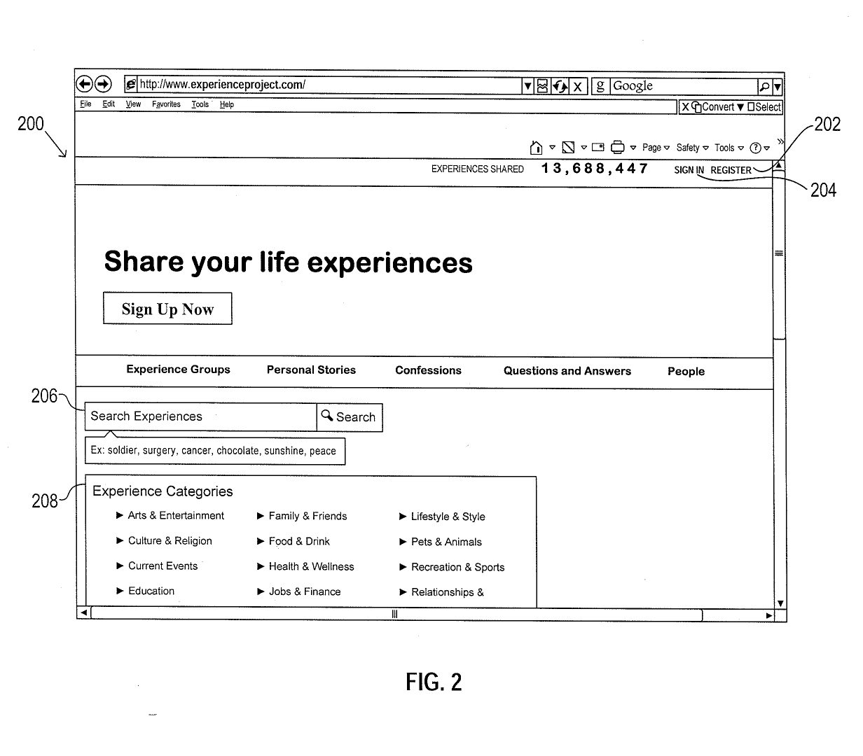

FIG. 2 illustrates a webpage 200 that may be accessible from the online forum system 108 shown in FIG. 1. The webpage 200 may comprise one of the webpages 118 for the online forum system 108 shown in FIG. 1. The webpage 200 may allow users to register 202 as a member of the online forum system 108, thus creating log-in information and supplying demographic information which is stored in the database 122 shown in FIG. 1. The webpage 200 may allow users to sign-in as a member of the online forum system 108.

In one embodiment, the online forum system 108 shown in FIG. 1 may prompt users to author textual data on the online forum system 108. Such textual data may include life stories or other narratives. The textual data may generally comprise any form of text conveying information. The textual data may convey a certain emotion. The online forum system may prompt users to author such textual data by requesting users to describe personal events in the users' own lives. Upon the online forum system 108 receiving textual data authored by a user, the textual data may be stored in a database 122 shown in FIG. 1, for example. Data may be stored indicating the textual data was authored by a certain author.

Referring to FIG. 2, the textual data may be available for other users to search and view. Other users may input search terms into a search box 206 to retrieve and view textual data on the online forum system 108 shown in FIG. 1. In addition, the users may select categories of topics 208 that describe the content of the textual data. The users may then view the textual data associated with a particular topic 208. Such topics may include “pets and animals,” “current events,” “food and drink,” and the like. In one embodiment, the online forum system 108 may prompt the author of the textual data to select a topic for the textual data. The online forum system 108 may group the textual data with other textual data based on the topic selected by the author.

Users may be able to identify other users based on the information conveyed in the textual data. The online forum system may serve as a forum for multiple users to share textual data representing emotions. The users may read the textual data to learn about other users' experiences and understand that other individuals have similar experiences. In addition, a user may attempt to network with the author of textual data based on the information conveyed in the textual data. For example, a user may find that another user authored a story about a pet. The users may have similar experiences regarding the pet, and may communicate regarding the shared experience. The users may form a network of users based on the content of the textual data.

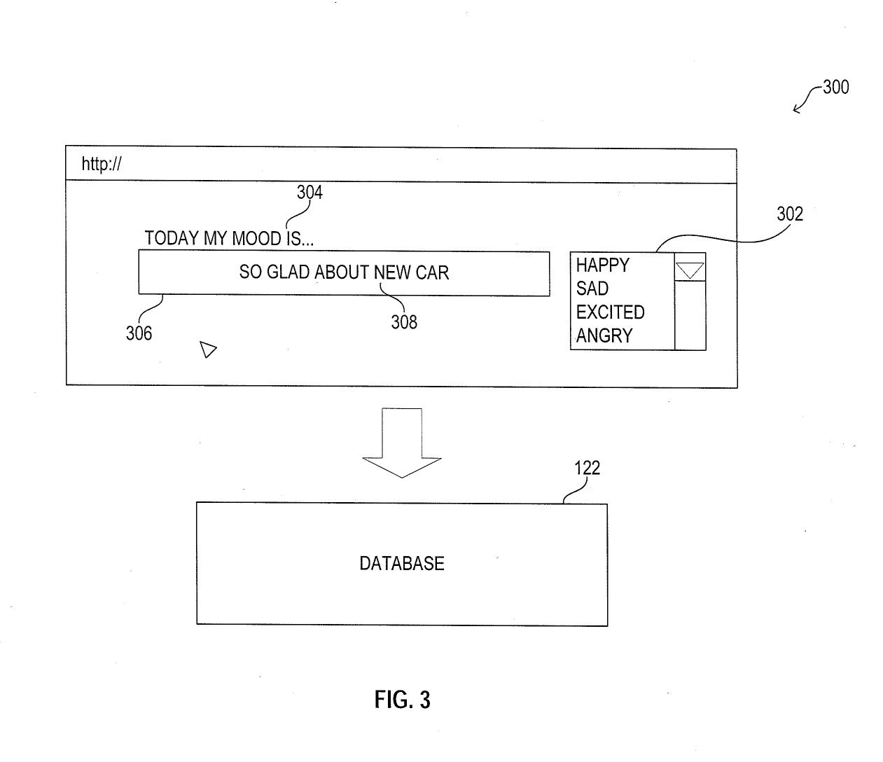

In one embodiment, the online forum system 108 shown in FIG. 1 may prompt a user to tag textual data with an emotion. Referring to FIG. 3, such prompting may include providing a webpage 300 with a list of predetermined emotions 302 to the user, or providing a text prompt 304 requesting that the user inputs an emotion, or generally allowing a user to select an emotion, or the like. The online forum system receives a tag set by the user, which is associated with an emotion and associates the textual data with the emotion. In one embodiment, a text box may be provided that allows the user to type in an emotion, which may not be provided on the list of emotions. In an embodiment in which a list of predetermined emotions is used, the list of predetermined emotions 302 may be stored in the database 122.

The user may author textual data 308 in a text box 306 on the webpage 300. The user may tag the textual data 308 that he or she authored with a selected tag that represents an emotion. The emotion may be one of a predetermined emotion 302 from the list of predetermined emotions 302 on the webpage 300. In one embodiment, the emotion may be an emotion that the author comes up with that is not provided on the list of emotions. Thus, the online forum system 108 shown in FIG. 1 may prompt the user to describe the textual data 308 the user authored, by tagging the textual data 308 with the emotion conveyed in the textual data 308.

In one embodiment, a user may tag textual data that another user authored. In one embodiment, a longer piece of textual data 308 is utilized, for example a long narrative. Multiple users may tag the long narrative with emotions 302, which may be similar emotions or different emotions. The list of predetermined emotions may be displayed on the online forum system 108 to multiple users of the online forum system 108. In this embodiment, the responses of multiple users may be used to establish a compiled list of emotions that multiple users have produced. Any number of users or emotional tags may be used to tag the narrative.

In an embodiment in which a list of predetermined emotions is provided, the predetermined emotions 302 available for selection by the user may be set by a third party. The third party may be an operator, controller, developer, or administrator of the online forum system 108 shown in FIG. 1. The predetermined emotions 302 may be selected to represent a broad spectrum of emotions a human may feel throughout his or her lifetime. Such emotions may range among common emotions, such as sad or happy, or excited or calm; may include emotions that are more inward-looking such as embarrassed or ashamed; or emotions that are more outward-looking, such as angry or annoyed. In one embodiment, approximately 130 emotions, or at least 130 emotions, may be available for selection by the author or other user. In one embodiment, a user may request from the third party that certain emotions be added to the list of emotions. The third party may add the emotion to the list if desired.

Preferably, the textual data 308 input by the user includes relatively short portions of text, on the order of a few sentences. The short portions of text therefore convey about one defined emotion, capable of being identified and tagged.

For example, in the embodiment shown in FIG. 3, the author has input the textual data 308 “so glad about new car” into a text prompt 304 area. The author then has the option to select which emotion to tag the textual data 308 with. The author is prompted to tag the textual data 308 with an emotion. The emotion may be one of the predetermined emotions 302 from a drop-down list. The author may select an appropriately positive emotion such as “happy,” for example. A similar tag may be used by any other user regarding textual data.

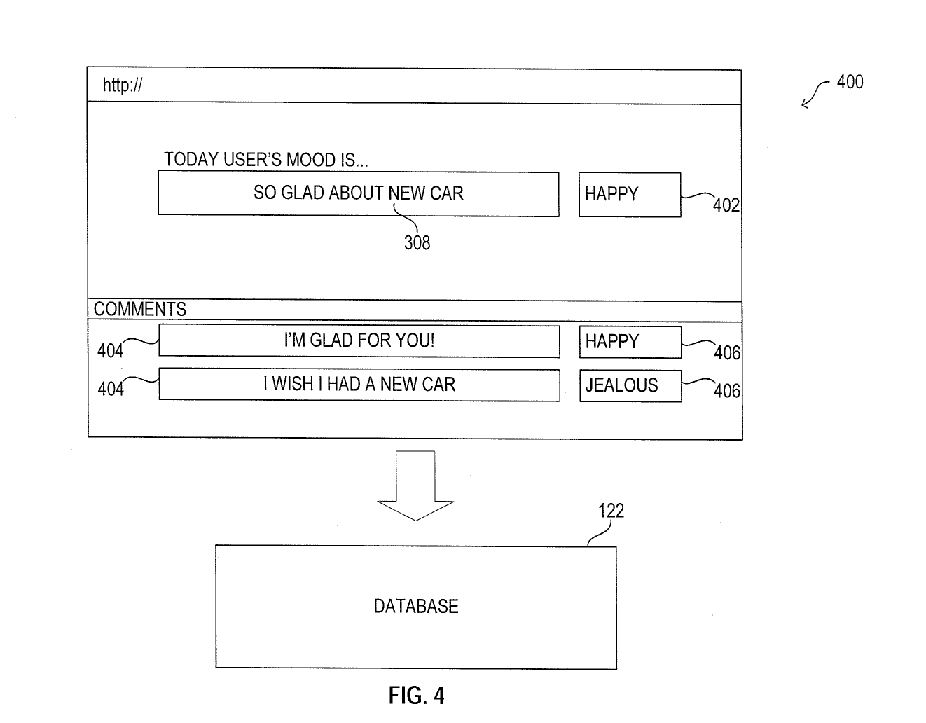

The textual data may then be published on a webpage 118 of the online forum system 108 shown in FIG. 1, for other users to view the textual data, or the selected emotion, or both. FIG. 4 illustrates an embodiment in which the textual data, and the emotion 402 are displayed on a webpage 400 of the online forum system 108 shown in FIG. 1. Other users input comments 404 onto the webpage 400 and tag their comments 404 with emotions 406, similar to how the original author tagged the textual data 308 with an emotion 402.

FIG. 4 shows another user provided the comment 404 of “I'm glad for you!” and tagged the comment with an emotion 406 of “happy.” Another user provided the comment 404 of “I wish I had a new car” and tagged the comment 404 with an emotion 406 of “jealous.” Multiple users may therefore be allowed to provide comments on the textual data provided by other users of the online forum system and tag his or her comment with its own emotion tag. Multiple users may be allows to access and retrieve the textual data to provide comments using a web browser, for example. In this manner, users are encouraged to author and tag their own expressions, and to share them with other users of the online forum system. In one embodiment, the online forum system 108 identifies user names of any user providing textual data or comments to other users of the online forum system 108.

The textual data 308 that was tagged by the author, and the emotional tag selected by the author are stored in a database 122. Other textual data tagged by non-authors, and other emotional tags selected are also stored in the database. The database 122 may be incorporated as part of the server 114 shown in FIG. 1. In one embodiment, the database may not be incorporated as part of the server 114, and may comprise a separate memory device located as desired. The database 122 may retain a listing of multiple textual data 308, 404 input on the online forum system 108 shown in FIG. 1, and the associated emotions 402, 406 tagged by the users. In this manner, the database retains a store of certain words used to convey emotions, and the emotions the words actually convey, as viewed from the perspective of the author. The database may also retain a listing of the user information associated with each item of textual data 308, 404 including age, gender, and geographic information. The database may store all demographic information retrieved regarding the users.

A benefit of having an author tag his or her own textual data with an emotion is that the author may be the only individual who truly knows what emotion is actually expressed in the author's own text. The author may be subtly conveying an emotion in words that others cannot easily identify. In addition, the author is disincentivized to fabricate the textual data, and the tagging process, because the online forum system 108 shown in FIG. 1 is designed to encourage networking among users with similar personal stories. In an embodiment in which a user is able to tag textual data that the user did not author, information may be derived that indicates how different kinds of people interpret text in differing emotional ways. Any of the operations discussed above need not be performed by a “user” or member of the online forum system 108, but may be performed by any individual.

In one embodiment, the textual data 308, 404 and the tagged emotions 402, 406 may be processed by an emotion identification system 110 shown in FIG. 1. The emotion identification system 110 may comprise components separate from the server 114 of the online forum system 108, and may transfer data between the online forum system 108 and the emotion identification system 110 using the internet 106. In one embodiment, the emotion identification system 110 may be incorporated on the server 114 of the online forum system 108. In one embodiment, the emotion identification system 110 may communicate with the online forum system 108 through any form of communication, for example, the emotion identification system 110 may be integrated on the same hardware as the online forum system 108.

The emotion identification system 110 may include a processor 128 and memory 130. The processor 128 executes instructions to perform the operations of the emotion identification system 110. The memory 130 stores instructions or data the processor 128 executes or operates upon. A communications node 132 may be utilized in an embodiment in which the emotion identification system 110 communicates with the online forum system 108 through the internet 106. The communications node 132 may comprise any device capable of communicating over the internet 106, for example, a modem or the like. Communication methods other than the internet may be utilized if desired.

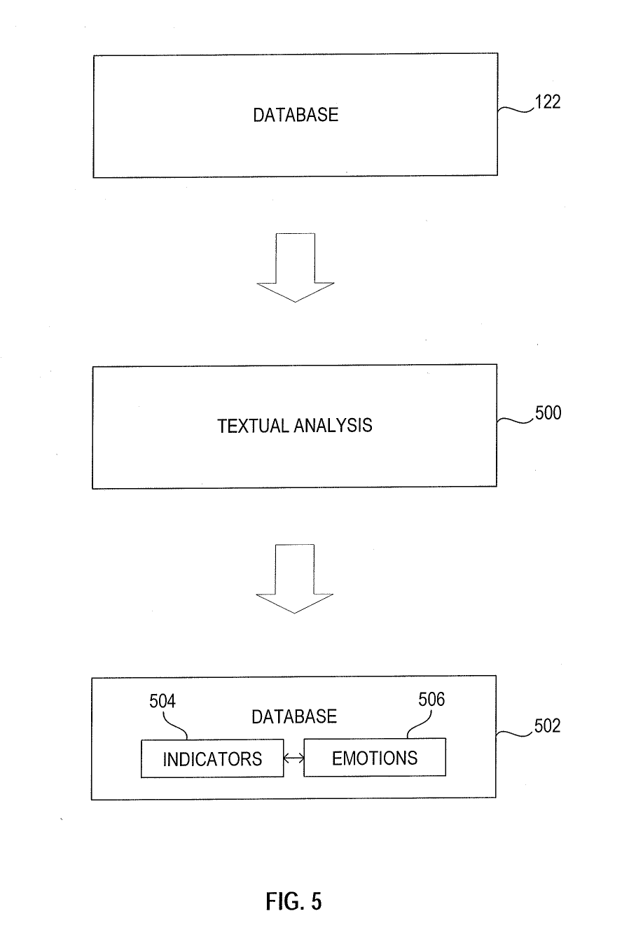

The emotion identification system 110 is configured to process the information supplied by the online forum system 108. Referring to FIG. 5, the emotion identification system 110 may receive the textual data and the associated tagged emotions from the database 122 of the online forum system 108. The emotion identification system 110 may perform textual analysis on the textual data to uncover the emotional content of the words, punctuation, or other semantic elements of the textual data. The textual analysis 500 processing results in a database 502 of data indicators 504 that define the emotional content of the textual data and that indicate emotive features of the textual data. The data indicators 504 are associated with, or correspond to, the emotions 506 tagged by the users for the textual data. The data indicators may result from a textual analysis process including latent semantic analysis, positive pointwise mutual information, or any other method of textual analysis that defines the emotional content of the textual data and that indicates emotive features of the textual data.

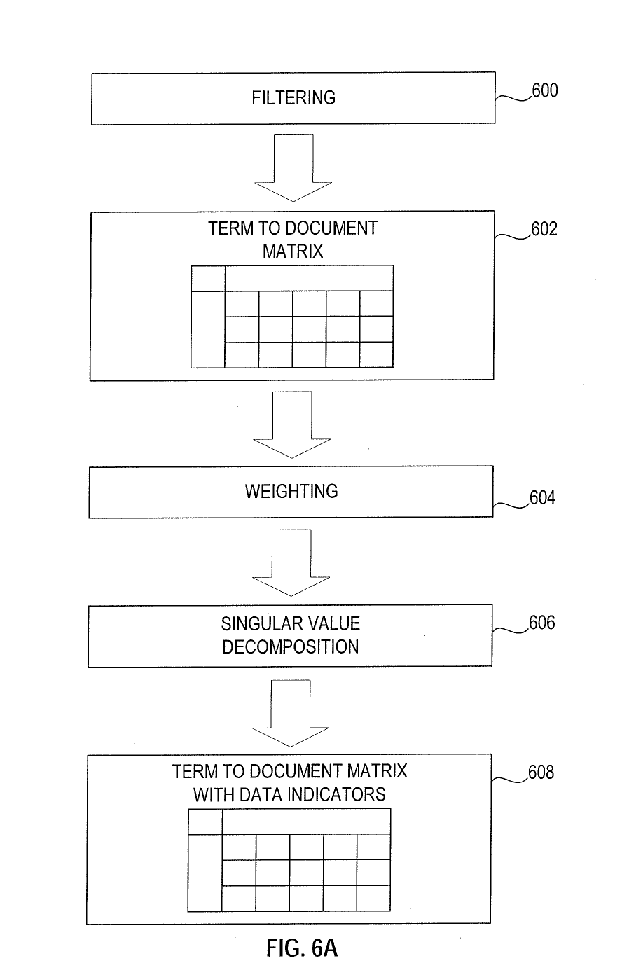

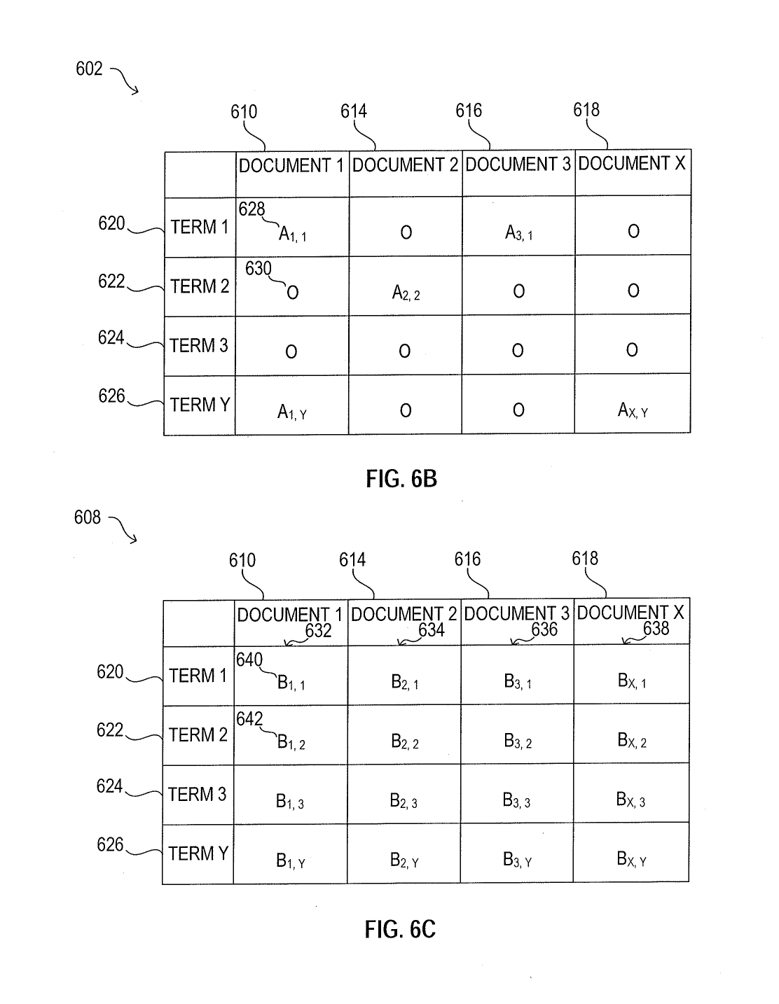

In one embodiment, the textual analysis 500 may include latent semantic analysis. FIG. 6A illustrates textual analysis steps that may be performed to produce data indicators defining emotional content of the textual data using latent semantic analysis. In one step, the textual data from the online forum system that was tagged with at least one emotion is filtered 600. The filtering 600 may include a tokenization process, to determine which terms may be present in the textual data. The tokenization process may break sentences, utterances, or expressions into specific terms. Such terms may include words, punctuation, emoticons, n-grams, or phrases. In one embodiment, the tokenization process may be able to identify terms such as emoticons, sentiment-indicative punctuation, such as the punctuation “!? . . . ” which may be found in text, and internet-specific constructions such as #hashtags, @users, and http://urls.com. The tokenization process may also be able to normalize elongations of terms, such as normalizing “hahahahaha” and “hahahah” to “hahaha,” or normalizing “wooooooow” and “wooow” to “woow.” In addition, a process of discounting for the textual data may be applied if desired to account for term-document combinations that were not previously seen before. For example, a good-turing, contextual, or laplace discounting method may be applied.

The filtering 600 may also exclude words, punctuation, or emoticons that have been determined to not effectively convey emotions, such as proper names and geographical indicators.

The filtering 600 process may serve to retain slang terms, misspellings, emoticons, or the endings of words, because such terms may convey emotion in common discourse. In addition, such slang terms, misspellings, emoticons, or the endings of words, also convey information, for example demographic information, about the author. This information may be stored in a database and correlated with the demographic information retrieved directly from the user upon the user registering with the online forum system. The information may also be correlated with any other demographic information regarding the user.

After the textual data is filtered 600 to identify and/or remove certain terms as desired, a term-to-document matrix 602 may be formed correlating the terms used in the textual data against the piece of textual data in which it is contained. For example, each piece of textual data input by a user may be considered a “document.” In addition, textual data may be broken up into smaller lengths of text each considered to be a “document.” The user may input the textual data in the manner described in relation to FIGS. 3 and 4. Each term remaining after the tokenization process within the document may be considered a “term.” Each document and term may be arranged in a matrix to indicate a correspondence between the documents and the terms contained within each document. Each document may be listed along a horizontal axis of the term-to-document matrix 602 and the terms within the term-to-document matrix 602 may be listed on the vertical axis. The appearance of a term within each document is marked within the term-to-document matrix 602. Accordingly, a listing of documents and the frequency of terms appearing in those documents is produced. The term-to-document matrix 602 may be populated with as many pieces of textual data as desired. Each piece of textual data is preferably tagged with an emotion, as discussed in regard to FIGS. 3 and 4. Thus, each column, or “document,” of the term-to-document matrix is associated with the emotion tagged by the user.

In one embodiment, the term-to-document matrix 602 may be formed in a manner that every piece of textual data input by users associated with a particular emotion is combined into one document associated with that emotion. For example, every piece of textual data input by users associated with the emotion “happy” is combined into a single document including all of the textual data associated with the emotion “happy.” Thus, each emotion will have its own defined document.

Particular terms in the term-to-document matrix 602 may be weighted 604 more greatly depending on the significance of the term. The significance of a term may be determined based on the relative ability of the term to convey emotional content. For example, adjectives and adverbs may be given greater weight, because they typically serve more expressive roles in common speech. Certain classes of nouns such as proper nouns or common nouns (e.g., “cat”) may be given less weight because they typically convey less information. The weighting may comprise multiplying the term listed in the term-to-document matrix 602 by a scalar, to enhance the value of the term within the term-to-document matrix 602, or to decrease the value of the term within the term-to-document matrix 602. In certain embodiments, the weight given to certain types of words may be varied as desired. In certain embodiments, the entries in the term-to-document matrix 602 may not be weighted.

A mathematical operation known as a singular value decomposition 606 may be applied to the term-to-document matrix 602. The singular value decomposition 606 reduces the dimensionality of the term-to-document matrix 602 by removing noise and preserving similarities between the information contained within the term-to-document matrix 602. The singular value decomposition 606 determines the important discriminative characteristic terms for each document and identifies the features of each document that define the emotional content of the document. The resulting features of the document that define the emotional content of the document are data indicators. The singular value decomposition 606 produces the data indicators by associating terms that were not within the original textual data, with terms of other textual data, based on the presence of these terms together in all textual data. Thus, each data indicator represents the presence of terms within the textual data and the probability of certain synonyms being present in the textual data. Each resulting data indicator for each document corresponds to the emotion tagged for that document, whether by the author or a non-author.

FIG. 6B illustrates a representation of a term-to-document matrix 602 for use with latent semantic analysis of the textual data. The term-to-document matrix 602 includes columns 610, 614, 616, 618 that correspond to each document. Each document may represent a piece of textual data, which is tagged with an emotion. In another embodiment, the textual data may represent a combination of pieces of textual data that all correspond to the same emotion. The term-to-document matrix 602 includes rows 620, 622, 624, 626. Each row may represent a term that may be present in a particular document. For example, the entry 628 indicates a value of A_{1,1} for “Term 1” in “Document 1.” Thus, Term 1 is present in Document 1 and is given a value of A_{1,1}. In addition, the entry 630 indicates a value of “0” for “Term 2” in “Document 1.” Thus, “Term 2” is not present in “Document 1.” The remaining entries in the representative term-to-document matrix are similarly filled.

FIG. 6C illustrates representation of a term-to-document matrix 608 with data indicators 632, 634, 636, 638, which result from the singular value decomposition step 606 described in relation to FIG. 6A. The data indicators are the entries in the columns 610, 614, 616, 618 of the term-to-document matrix 608. These entries define the emotional content of each associated document. For example, the entry 640 indicates a value of B_{1,1} for “Term 1” in “Document 1.” Thus, the document conveys a value of B_{1,1} for “Term 1” in “Document 1.” In addition, the entry 642 indicates a value of B_{1,2} for “Term 2” in “Document 1.” It is noted that although “Term 2” was not actually present in “Document 1,” the singular value decomposition 606 process reveals that “Document 1” actually conveyed a value of B_{1,2} for “Term 1,” which is a non-zero value. Thus, the latent emotive content of “Document 1” is represented by value B_{1,2}. The entries for “Document 1” define the emotional content of “Document 1.”

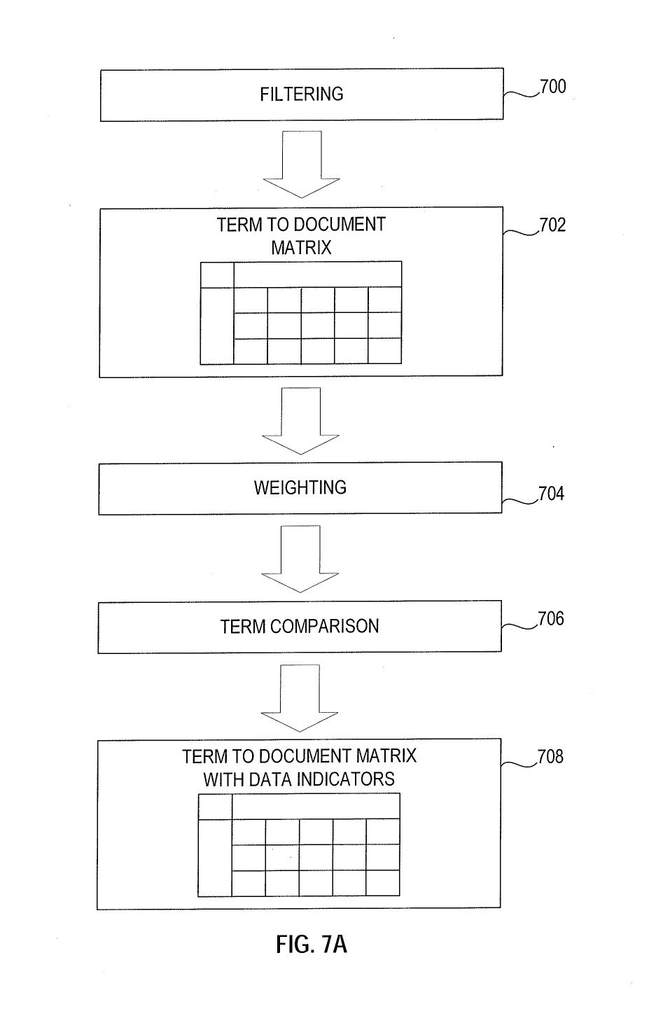

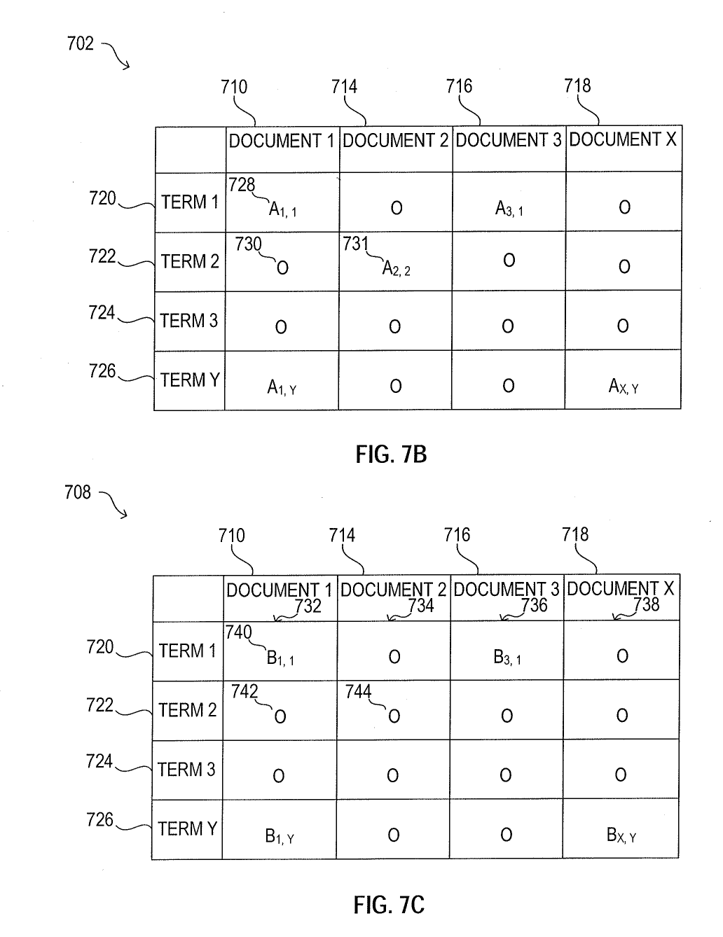

In one embodiment, the textual analysis 500 referred to in FIG. 5 may include a process using positive pointwise mutual information (PPMI). The process, shown in FIG. 7A, may include first filtering 700 the textual data in a similar manner as discussed above in regard to a latent semantic analysis technique. For example, the filtering 700 may include a tokenization process, to determine which terms may be present in the textual data. Such terms may include words, punctuation, or emoticons. The filtering 700 may then exclude words, punctuation, or emoticons that have been determined to not effectively convey emotions, such as proper names and geographical indicators. In addition, a process of discounting for the textual data may be applied if desired to account for term-document combinations that were not previously seen before. For example, a good-turing, contextual, or laplace discounting method may be applied.

In addition, similar to the process described in relation to FIGS. 6A-6C, a term-to-document matrix 702 may be formed correlating the terms used in the textual data against the piece of textual data in which it is contained. The term-to-document matrix 702 may be formed in an identical manner as described in relation to FIGS. 6A-6C. A weighting process 704 may also be performed in an identical manner as described in relation to FIGS. 6A-6C.

The terms of the textual data are then compared 706 to the terms within the same “document” and the terms within the other “documents” using a positive pointwise mutual information method. The comparison method 706 determines which terms of a document more strongly express the emotional content of that document. The process determines the mutual information between each term and the emotion conveyed by the “document” and weights each term accordingly. The mutual information provides information on whether the probability of the document and term occurring together is greater than the probability of each in isolation, specifically whether they depend from one another.

Generally, the method of comparison 706 includes finding a comparison value for each term. The comparison value is given by the equation:

$$comparison value ( term , document ) = log \frac{P ( document , term )}{P ( document ) * P ( term )} = log \frac{P ( document \vert term )}{P ( document )}$$

Thus, the comparison value is determined by first determining the probability that a “term” occurs in a “document” with respect to all “documents.” This probability is divided by the probability that the “term” appears in all documents, and is also divided by the probability that the particular “document” appears in all documents. A logarithmic value may be taken of the resulting value to produce the comparison value. If the logarithmic value is greater than zero, then the comparison value for that term is recorded. If the logarithmic value is less than zero, then the comparison value for that term is set to zero. Thus, only the comparison values for terms that strongly convey the emotional content are retained. The remaining comparison values for that “document” produce the data indicators for that document, which define the emotional content of the textual data.

The process may be repeated for all textual data until at least one data indicator is produced for each “document” and all related terms for all textual data.

FIG. 7B illustrates a representation of a term-to-document matrix 702 for use with the PPMI process described in regard to FIG. 7A. The term-to-document matrix 702 includes columns 710, 714, 716, 718 that correspond to each document. Each document may represent a piece of textual data, which is tagged with an emotion. In another embodiment, the textual data may represent a combination of pieces of textual data that all correspond to the same emotion. The term-to-document matrix 702 includes rows 720, 722, 724, 726. Each row may represent a term that may be present in a particular document. For example, the entry 728 indicates a value of A_{1,1} for “Term 1” in “Document 1.” Thus, Term 1 is present in Document 1 and is given a value of A_{1,1}. In addition, the entry 730 indicates a value of “0” for “Term 2” in “Document 1.” Thus, “Term 2” is not present in “Document 1.” The entry 731 indicates a value of A_{2,2} for “Term 2” in “Document 2.” The remaining entries in the representative term-to-document matrix are similarly filled.

FIG. 7C illustrates a representation of a term-to-document matrix 708 with data indicators 732, 734, 736, 738, which result from the term comparison step 706 described in relation to FIG. 7A. The data indicators are the entries in the columns 710, 714, 716, 718 of the term-to-document matrix 708. These entries define the emotional content of each associated document. For example, the entry 740 indicates a value of B_{1,1} for “Term 1” in “Document 1.” Thus, the document conveys a value of B_{1,1} for “Term 1” in “Document 1.” In addition, the entry 742 indicates a value of “0” for “Term 2” in “Document 1.” The entry 742 has a value of “0” because that term is never present in “Document 1.” In addition, it is also noted that the entry 744 for “Term 2” in “Document 2” now has a value of “0.” This is because the logarithmic value described in regard to FIG. 7A is less than zero for this entry 744, and the comparison value for that term is therefore set to zero. The entries for “Document 1” define the emotional content of “Document 1.” Each entry represents a data indicator that defines the emotional content of that document.

In other embodiments, data indicators may be produced through any other mathematical process that reveals the emotional content of a particular piece of textual data. In other embodiments, data indicators may simply comprise the words contained within the textual data. In other embodiments, data indicators may comprise the words contained within the textual data that remain after a filtering process operates on the textual data to reveal more emotive terms of the textual data.

In one embodiment, additional features, such as syntactic features and demographic features may be added as additional data indicators to the data indicators shown in FIGS. 6C and 7C for example. These additional features may not be lexical in nature, but are general semantic features that are generally found to be good features for emotion tasks, such as finding the density of first person personal pronouns, adverbial phrases, valence-shifters such as “not,” “but,” etc., or pivot words that change the emotional meaning of a previous or subsequent phrase. In this manner the data indicators may comprise a combination of lexical and semantic features. The demographic features may include the demographic information stored regarding a user of the online forum system 108, as discussed in regard to FIG. 1.

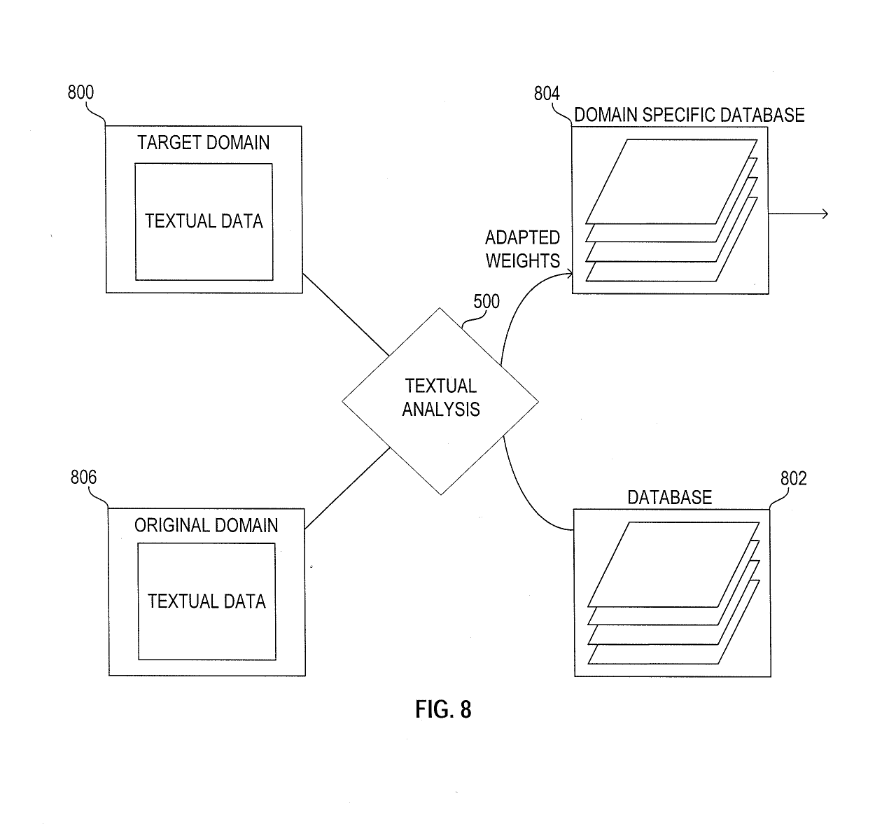

Referring to FIG. 8, in certain embodiments, the data indicators may be tailored to include data from another target domain 800 of textual data, which may not be tagged with at least one emotion. Such target domains 800 may be based on a topical category, for example, one of the categories 208 shown in FIG. 2, such as “pets and animals” or “recreation and sports.” The textual analysis 500 methods discussed above may modify a database 802 including data indicators 608, 708 referred to in regard to FIGS. 6A and 7A, to include similar terms from the target domains 800. Thus, a domain specific database 804 of data indicators is produced.

For example, in an embodiment in which latent semantic analysis is used, the textual data of the target domain 800 may be broken up into “documents,” and the words of the documents may comprise “terms.” The documents and terms of the target textual data may be added to the term-to-document matrix of the original domain 806 prior to the singular value decomposition (606 in FIG. 6A) being performed. Thus, the textual analysis steps shown in FIG. 6A are performed on the combination of the original domain 806 textual data and the target domain 800 textual data. In this manner, the resulting data indicators may be weighted to reflect the terms used in the target domain 800. A domain specific database 804 of data indicators is produced. In an embodiment in which PPMI is used, the documents and terms of the target textual data may be added to the term-to-document matrix of the original domain 806 prior to the term comparison (706 in FIG. 7A) being performed. Similarly, in this manner, a domain specific database 804 of data indicators is produced.

The textual data of the target domain 800 may derive from the online forum system 108 shown in FIG. 1, or, may derive from a data system 112, which may be operated by a third party. The data system 112 may comprise any database or store of textual data, including printed textual data, in the form of a book, report, journal entry, or the like, or online sources such as websites, email databases, or short data transmissions such as sms messages, or other stores of transmitted data. The third party data may be received by the online forum system 108 and/or the emotion identification system 110 through electronic transmission or physical transmission. The emotion identification system 110 may process the information received from the data system 112 in the same manner as discussed above for the textual data produced on the online forum system 108.

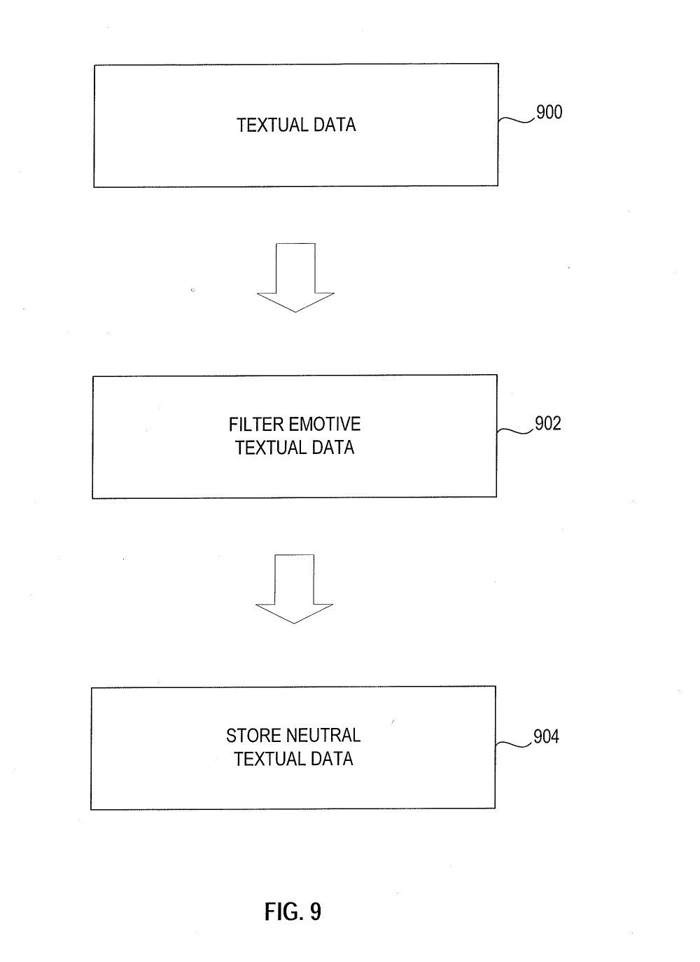

FIG. 9 illustrates a process for collecting non-emotive or “neutral” data for use with the emotion identification system 110 shown in FIG. 1. The process includes a first step of receiving textual data 900 from the data system 112 shown in FIG. 1, which may be operated by a third party. The textual data 900 is not tagged with an emotion, and preferably comprises non-emotive text such as news reports or the like. This textual data 900 may be broken up into pieces such as sentences or paragraphs, and each piece may be compared to the data indicators 504 represented in FIG. 5, to determine a similarity between each piece of textual data 900 and the data indicators 504. The pieces of textual data 900 may be compared by placing the terms in a term to document matrix as described in relation to the matrices 602, 702 of FIGS. 6A and 7A, and comparing the “document” columns (representing each piece of textual data 900) to the data indicators 504. A similarity measure may be produced, such as a cosine similarity. Preferably, there will be minimal similarity between the pieces of textual data 900 and the data indicators 504. This is because the textual data 900 will likely include little emotive content. However, it is also possible there may be some similarity between the pieces of textual data 900 and the data indicators 504. If so, this is likely because some piece of the textual data 900 (e.g., a sentence or paragraph) is emotive. This emotive textual data is then identified and filtered 902 out. The retained neutral textual data is stored 904.

In one embodiment, the emotions represented by the data indicators may be classified in a manner that produces groupings of emotions. In one embodiment, the groupings of emotions may be present based on a known interpretation of emotions. The known interpretation of emotions may allow a hierarchy of emotions to be formed. In other embodiments, the groupings formed may comprise a taxonomy or ontology of emotions. This process essentially imposes structure on the vague concept of human emotion.

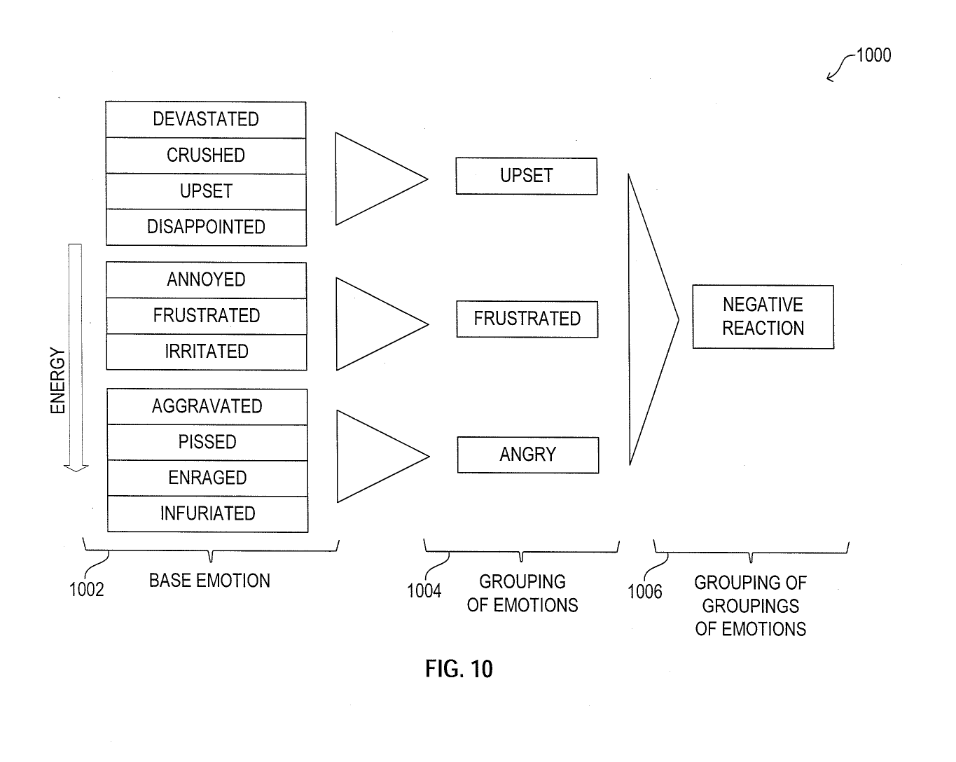

FIG. 10 illustrates a hierarchy of emotions 1000. For example, the base emotions 1002 of “devastated,” “crushed,” “upset,” and “disappointed” may be known to correspond to the overall grouping of emotions 1004 of “upset.” The label of “upset” for the grouping of emotions 1004 is applied even though the term “upset” is also applied to one of the base emotions 1002. The base emotions 1002 of “aggravated,” “pissed,” “enraged,” and “infuriated” may be classified as the grouping of emotions 1004 of “angry.” The label of “angry” for the grouping of emotions 1004 is applied even though the term “angry” is not applied to one of the base emotions 1002.

In addition, the grouping of emotions 1004 of “upset,” “frustrated,” and “angry” correspond to the grouping of the groupings of emotions 1006 of “negative reaction.” In this manner, each emotion, for example a base emotion 1002, that may have been selected by the author of the textual data may be ordered into a hierarchy of emotions. In certain embodiments, the classification of emotions may be based on a particular feature of the emotions. The particular feature may be the arousal level, or energy of an emotion, for example. For example, the base emotions 1002 of “devastated,” “crushed,” “upset,” and “disappointed” may convey less energy than the emotions of “annoyed,” “frustrated” and “irritated.” In addition, the emotions of “annoyed, “frustrated” and “irritated” may convey less energy than the emotions of “aggravated,” “pissed,” “enraged,” and “infuriated.” The groupings of emotions 1004 may therefore be selected based on whether this characteristic is similar across base emotions 1002.

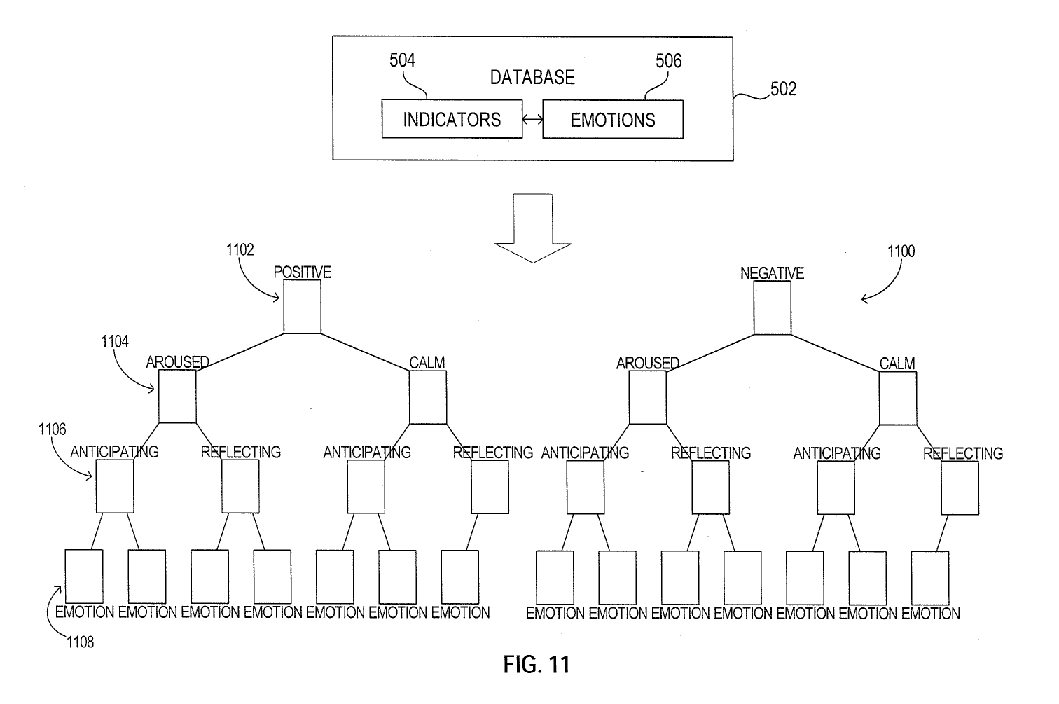

In certain embodiments, the hierarchy of emotions may be classified as desired. Any form of classification may be used, depending on the desired result. FIG. 11 illustrates a hierarchy 1100 that establishes the broadest classifications of the emotions at a highest level 1102 of the hierarchy, and leaves the more narrow, or granular emotions at the lowest level 1108 of the hierarchy. Groupings of emotions 1104, 1106 are used between the lowest level 1108 and highest level 1102. The classification of emotions additionally groups the data indicators 504 representing the textual data associated with the emotions 506.

In one embodiment, a hierarchy of emotions may be determined by comparing the data indicators 504 with one another to determine the strength of similarity between each of the data indicators 504. Each column of data indicators 632, 732 as shown in FIG. 6C or 7C may define a feature vector representing a value for that associated document. If the data indicators 504 are produced using latent semantic analysis techniques, then the feature vectors formed from the data indicators 504 may therefore be compared to feature vectors formed from other data indicators 504, and a relationship between the corresponding emotions may be determined. Any method of comparing the data indicators 504 of the feature vectors to produce a similarity measure may be used, including standard Euclidean distance metrics. For example, a cosine similarity may be produced between the feature vectors of the data indicators 504 to determine a degree of similarity between the feature vectors. If the data indicators 504 are produced using PPMI, then a similarity measure may be produced between the feature vectors of the data indicators 504 to determine a degree of similarity between the vectors.

The data indicators 504 may be grouped based on the degree of similarity between the data indicators 504. In one embodiment, a threshold value may be set that must be overcome before at least two emotions are determined to be similar. In this manner, associated emotions may be identified and classified as similar emotions, based on the similarity of the data indicators 504. The emotion identification system 110 may determine whether to classify the emotion associated with a feature vector with an emotion associated with another feature vector. The emotion identification system 110 may then classify the emotion associated with a feature vector with an emotion associated with another feature vector.

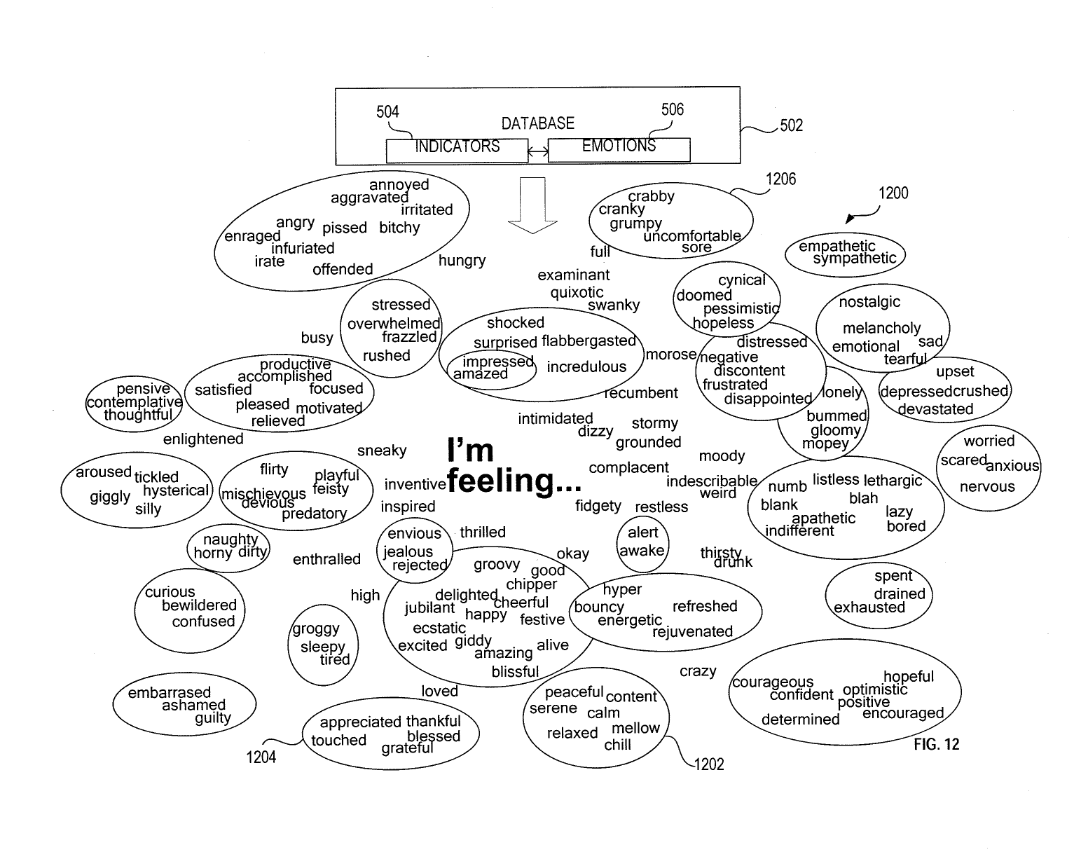

A map, or chart, may be produced displaying the similarity of the data indicators 504. FIG. 12 illustrates a two-dimensional chart illustrating groupings 1200 of base emotions produced based on the similarity of data indicators 504. Multiple levels of groupings and groupings of groupings may be determined based on the similarity of the data indicators. Localized groupings between certain emotions, and large scale groupings of local groupings may be identified. For example, a first grouping 1202 of “peaceful,” “content,” “serene,” “calm,” “relaxed,” “mellow,” and “chill” may represent generally positive emotions. A nearby localized second grouping 1204 of “appreciated,” “thankful,” “touched,” “blessed,” and “grateful” has similar positive features as the first grouping 1202, but includes more gracious emotions than the first grouping 1202. Thus, a relationship between the first grouping 1202 and the second grouping 1204 is identified based on the similarity of data indicators 504 representing certain emotions. Particularly, both the first grouping 1202 and the second grouping 1204 represent generally positive emotions. Further, a third emotion grouping 1206 of “crabby,” “cranky,” “grumpy,” “uncomfortable,” and “sore” is shown to be distant from the first localized grouping 1202. The third grouping 1204 is distant from the first grouping 1202 because the emotions of the third grouping 1204 represent generally negative emotions, unlike the generally positive emotions of the first grouping 1202. Thus, a relationship between the third grouping 1206 and the first grouping 1202 is identified based on the dissimilarity of data indicators 504 representing certain emotions. Any variety of graphs or charts of various predetermined emotions may be produced based on the similarity between the data indicators 504, for example including a three dimensional chart or map, or two dimensional chart or map.

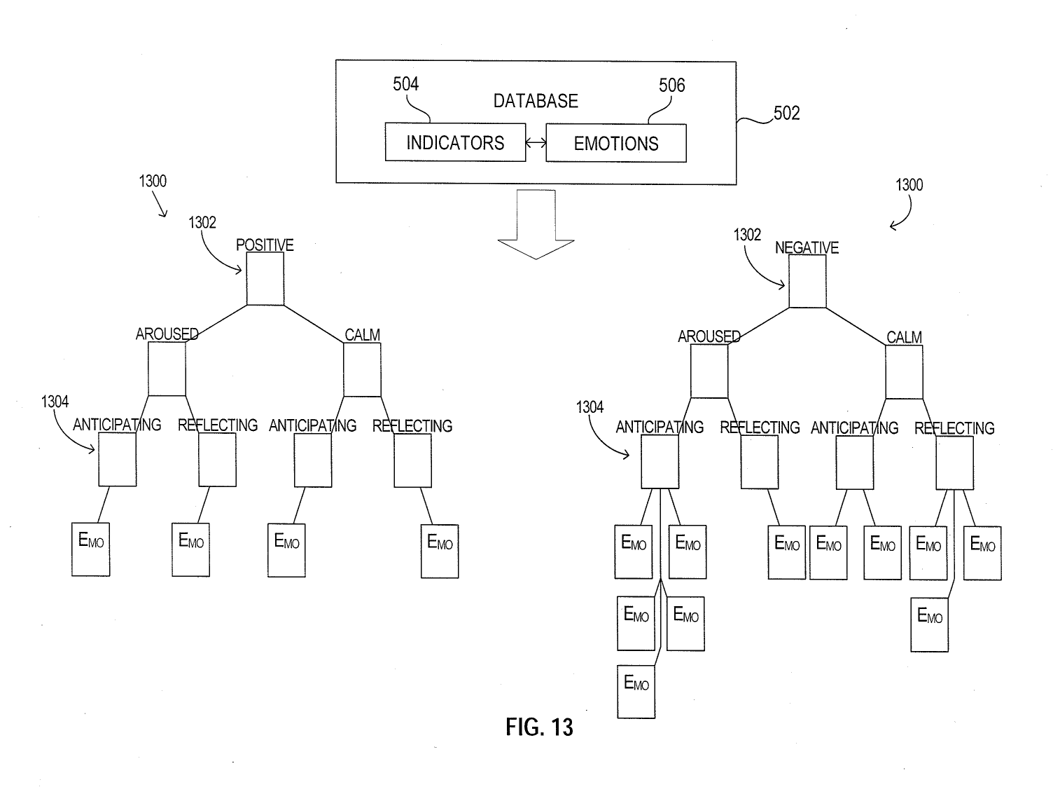

In addition, the groupings of emotions based on the similarity of the data indicators 504 may allow a hierarchy 1300 of emotions to be produced, as shown in FIG. 13. As discussed above, the similar emotions grouped together may produce localized groupings between certain emotions, and large scale groupings of local groupings. The localized groupings may constitute the low level 1304 groupings on the hierarchy, and the large scale groupings may constitute the higher level 1302 groupings on the hierarchy. For example, the first grouping 1202 of “peaceful,” “content,” “serene,” “calm,” “relaxed,” “mellow,” and “chill” shown in FIG. 12 may be grouped with the second grouping 1204 of “appreciated,” “thankful,” “touched,” “blessed,” and “grateful” because the groupings convey similar positive emotions. Thus, the first grouping and second groupings may constitute a low level 1304 grouping on the hierarchy, and the latter grouping of the first grouping and the second grouping with other groupings may constitute a higher level grouping on the hierarchy 1302. In this manner, a grouping of related emotions may be formed based on the actual language that is provided in the textual data. The hierarchy 1300 in this embodiment provides the benefit that the language used in the textual data defines the relationship between the emotions. In one embodiment, a low level grouping may include a single emotion, for example a single emotion associated with the grouping of a positive, aroused, and anticipating emotion as shown in FIG. 13. In addition, in one embodiment, once the data indicators 504 have been grouped, the data indicators of that grouping may be compared with data indicators of another grouping to determine a similarity between the groupings. The emotion identification system 110 may determine whether to classify an emotion group and another emotion group as being a similar grouping of groupings of emotions, based on a sufficient similarity between the respective data indicators of each grouping. The emotion identification system 110 may then classify the emotion group and the other emotion group as being a similar grouping of groupings of emotions.

In one embodiment, a hierarchy of emotions may be based on the behavior of a user utilizing the online forum system 108, shown in FIG. 1. The behavior may include the activity of a user to vary an emotional tag 302 provided by the user, shown in FIG. 3 for example. For example, the emotion identification system 110 may track when the user provides an emotional tag 302 and when the user provides a subsequent emotional tag 302 and what the user changes the emotional tag 302 to. The emotion identification system 110 may then determine how often the user changes the emotional tag 302 and may group the emotions based on the frequency that the emotion is changed into the subsequent emotion. In one embodiment, a graph may be produced in which every node is an emotion. An edge may exist between a first emotion and a second emotion if the user provides a tag with the second emotion, shortly after previously tagging the emotion as the first emotion. The magnitude of the edge's weight may be proportional to how often this transition occurs. The graph may represent transition probabilities between emotions and may encode which emotions are likely to turn into other emotions. A clustering algorithm may be used to come up with a clustering or grouping of emotions based on behavior and the order in which the emotions are typically expressed.

In one embodiment, the formation of a hierarchy of emotions may be performed prior to a textual analysis step 500 shown in FIG. 5. In this embodiment, the textual data retrieved from the online forum system 108 may be grouped or classified based on the emotional tags 402, 406 applied as discussed in regard to FIGS. 3 and 4. For example, a select category of emotion, such as “positive” or “negative,” may be selected and appropriate emotional tags 402, 406 may be selected for grouping. The textual data associated with these emotional tags 402, 406 may be combined into term-to-document matrices prior to the textual analysis step 500 being performed as shown in FIG. 5. In one embodiment, the textual data may be combined into about 20 general emotions, although another number of emotions may be utilized as desired.

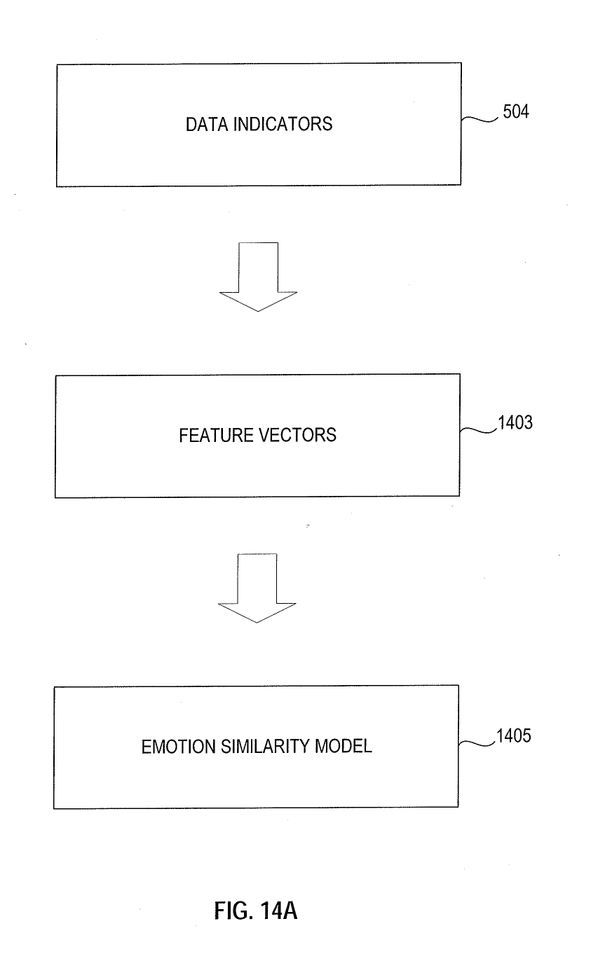

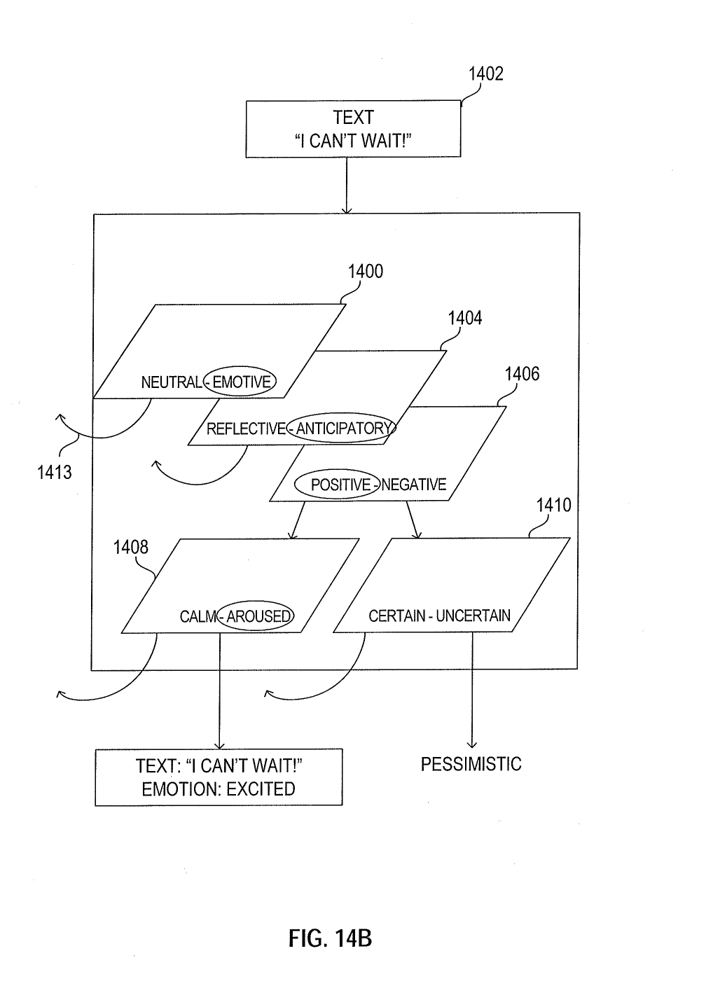

Referring to FIG. 14A, in one embodiment, the data indicators 504 of the database 502 may be used to form an emotion similarity model 1405 that defines a difference between different kinds of emotions. For example, once a series of emotions have been reduced down to a series of data indicators 504, an algorithm may be used to train an emotion similarity model 1405. The emotion similarity model 1405 may consider each set of data indicators 504 to comprise feature vectors 1403 discussed in regard to FIG. 11, and the emotion similarity model 1405 may be utilized to determine a similarity between the feature vectors 1403. The algorithms used may include support vector machines, naïve bayes, or maximum entropy models. Referring to FIG. 14B, the resulting emotion similarity model 1405 may include an emotion similarity model 1400 that distinguishes between neutral text or emotional text for example, an emotion similarity model 1404 may distinguish between reflective or anticipatory emotions for example, an emotion similarity model 1406 may distinguish between positive or negative emotions for example, an emotion similarity model 1410 may distinguish between certain or uncertain emotions for example, or a model 1408 may distinguish between calm or aroused emotions for example. Any kind of emotion similarity model defining a difference between different kinds of emotions may be produced.

The hierarchy of emotions may be utilized with the emotion similarity model to allow a model to be formed based on particular nodes of the hierarchy. For example, if a model is to be trained that distinguishes between anticipatory positive emotions and anticipatory negative emotions, then particular data indicators from those nodes that form feature vectors, are utilized to train the model. If a model is to be trained that distinguishes between anticipatory positive emotions and reactive positive emotions, then particular data indicators, forming feature vectors, from those nodes are utilized to train the model.

Upon development of the model, a piece of comparison text 1402 may be produced that is compared against the model. Data indicators of the comparison text 1402 may be produced, in a manner described in regard to FIG. 5 for example, and formed into feature vectors, in a manner described in regard to FIG. 11 for example, that are input into the model. The model 1400, 1404, 1406, 1408, 1410 then determines what the probability distribution of the comparison text 1402 is for each model 1400, 1404, 1406, 1408, 1410. The feature vectors of the data indicators 504 of the database 502 and the feature vectors of the comparison text 1402 are input into the model to determine a similarity between the comparison text 1402 and an emotion or grouping of emotions associated with the data indicators 504. Thus, a similarity measure may be produced for the comparison text 1402 to determine if it is more reflective or anticipatory, for example. The similarity measure may comprise a probability that the comparison text 1402 corresponds to an emotion or grouping of emotions. The similarity may be used to classify the comparison text 1402 as corresponding to an emotion or grouping of emotions.

The comparison text 1402 may be compared to multiple models 1400, 1404, 1406, 1408, 1410 sequentially, in a top-down approach. For example, as shown in FIG. 14B, a model 1400 may have been produced that distinguishes between neutral or emotive text 1400. This model 1400 may utilize the stored neutral textual data 904 described in regard to FIG. 9 if desired. For example, stored neutral textual data 904 and data indicators of the comparison text 1402 may be input into the model 1400. If the model 1400 indicates a similarity between the neutral textual data 904 and the data indicators of the comparison text 1402 that is higher than a threshold, then the comparison text 1402 may be classified as non-emotional text. If the model 1400 indicates a similarity between the neutral textual data 904 and the comparison text 1402 is lower than a threshold, then the comparison text 1402 may be classified as emotional text. In one embodiment, data indicators of the stored neutral textual data 904 may be produced in a manner described in regard to FIG. 5 for example, and formed into feature vectors, in a manner described in regard to FIG. 11 for example. The resulting data indicators of the stored neutral data 904 and the data indicators of the comparison text 1402 may be input into the model 1400 to determine a similarity between the neutral textual data 904 and the comparison text 1402. If the similarity is higher than a threshold, then the comparison text 1402 may be classified as non-emotional text. If the similarity is lower than a threshold, then the comparison text 1402 may be classified as emotional text.

In one embodiment, the model 1400 may distinguish between neutral or emotive text by any of the data indicators 504 of the database 502 and the comparison text 1402 being input into the model 1400. If the model 1400 indicates that a similarity between any of the data indicators 504 of the database 502 and the comparison text 1402 is lower than a threshold, then the comparison text 1402 may be classified as non-emotional text. If the similarity is higher than a threshold, then the comparison text 1402 may be classified as emotional text.

Thus, the model 1400 may produce a similarity measure that determines if the comparison text 1402 is more neutral or emotive. If the comparison text 1402 is neutral, then the text 1402 may be classified as non-emotional textual data and may no longer be considered (as represented by arrow 1413). If the comparison text 1402 is emotive, then the comparison text 1402 may be classified as emotional textual data and may be further compared to other models to determine a similarity measure between the text 1402 and the other models. Thus, in effect, a form of a decision tree may be utilized, in which the comparison text 1402 may be compared to successive models to determine a similarity between the comparison text 1402 and the model.

In the embodiment shown in FIG. 14B, the comparison text 1402 is compared to successive models until a most similar emotion of “excited” is determined. In this embodiment, a model has been utilized that allows the comparison text 1402 to indicate a single emotion. In other embodiments, a probability distribution may result from comparison text 1402 across multiple emotions or groupings of emotions. Data indicators from nodes of a hierarchy shown in FIG. 13 for example that form feature vectors may represent an emotion group. A feature vector of the comparison text 1402 and the feature vector of the emotion group may be input into an emotion similarity model to determine a similarity between the emotion group and the comparison text 1402. In one embodiment, a probability distribution (or confidence interval across emotions or a measure of the relative presence of a set of emotions) may be used to determine a most similar emotion, and/or be utilized to determine an entire distribution of similarities to produce the comparison text's emotion vector. The comparison text's emotion vector may be used as a further signal in information retrieval, or as a check to determine if the comparison text 1402 was correctly categorized to begin with.

In one embodiment, the similarity model 1400, 1404, 1406, 1408, 1410 may base the similarity decision on the similarity determined from the previous model. For example, the model 1406 may be modified to take into account whether the model 1404 found the comparison text 1402 to be reflective or anticipatory.

In one embodiment, the comparison text 1402 may take the form of a data transmission. Referring to FIG. 1, the data transmission may comprise a transmission sent over the internet 106 from a computer 102 or mobile device 104. The data transmission may be authored by an individual on a mobile device. The data transmission may take the form of an email, a posting on a website, a text message using sms, or the like. In one embodiment, the data transmission may be sent to the online forum system 108, and retrieved by the emotion identification system 110. In one embodiment, the data transmission may be sent to the emotion identification system 110 by a data system 112, which may comprise a third party data system 112. In one embodiment, the third party data system 112 may include a commercial receiver of data transmissions, for example, text messages using sms, or the like, or comments submitted online.

The data transmission may comprise textual data authored by an individual. The textual data may be used as the comparison text 1402 in a similar manner as discussed in regard to FIG. 14B. For example, the textual data of the comparison text 1402 may be compared to determine if it is emotive or non-emotive, or whether it may be classified into a certain grouping of emotions or classified as a certain emotion, in the manner discussed above in regard to FIG. 13.

In one embodiment, multiple data transmissions may be received and processed. The multiple data transmissions may have been sent by at least one individual during a span of time. The data transmissions may each be processed to determine if each data transmission is emotive or non-emotive, or whether it may be classified into a certain grouping of emotions, or classified as a certain emotion, in one of the manners discussed above in regard to FIG. 14B.

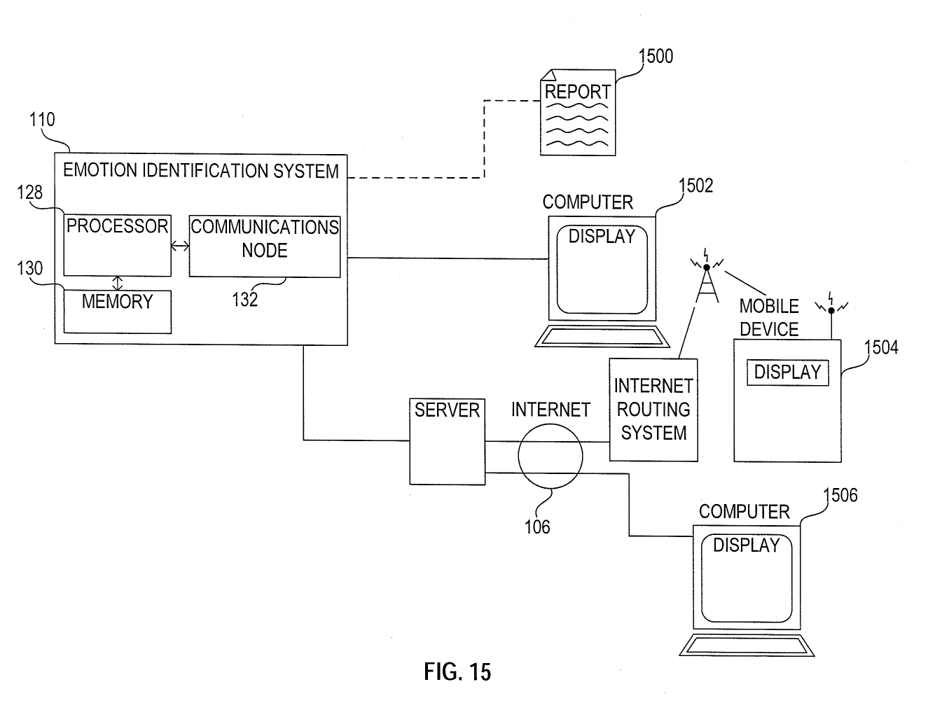

Referring to FIG. 15, the emotion identification system 110 may output results of the processing of a data transmission. The results may be displayed on a printed report 1500, on a computer display 1502, or may be delivered through the internet 106 to a mobile device 1504 or computer display 1506.

The results may include statistics regarding the data transmission, or multiple data transmissions that are received and processed by the emotion identification system 110. The statistics may reflect which of the data transmissions are classified according to the groupings of emotions, in a manner discussed above in regard to FIG. 14B, for example. In addition, each of the data transmissions may be compared to the groupings of emotions in any manner discussed in this application, for example in a manner discussed above in regard to FIG. 14B, to determine which grouping the data transmission is similar to.

The correspondence between the multiple data transmissions and a particular grouping of emotions may be identified and displayed as desired. The grouping may correspond to an emotion similarity model 1405 discussed in regard to FIG. 14A. The correspondence between a data transmission and a particular model may be displayed on a report 1500 as desired. For example, using the model 1404 shown in FIG. 14B, only the emotional groupings corresponding to anticipatory and positive emotions may be selected for review. Thus, a display may show the frequency that anticipatory and positive emotions are sent as data transmissions. Any level of granularity may be displayed as a statistic. For example, the frequency of the emotions “joy,” “anger,” “hopeful,” and “excited” may be selected for display.

In one embodiment, the data transmissions may be processed to determine a frequency of emotive versus non-emotive responses. The distinction between emotive and non-emotive responses may be determined in any manner discussed in this application, for example in a manner discussed above in regard to FIG. 14B.

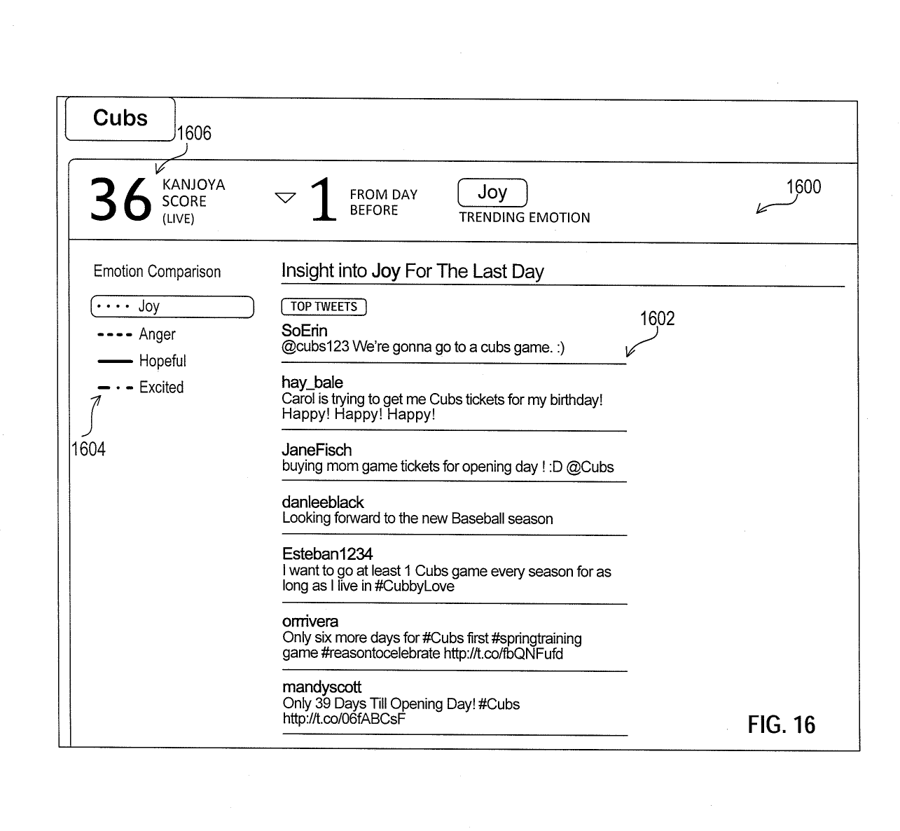

A report may be produced, displaying any series of statistical data as desired. Such statistical data may include whether certain data transmissions are emotive or non-emotive, and/or whether the data transmissions correspond to a certain emotion or grouping of emotions. Other statistical data may include displaying the original textual data of the data transmission sent. Other statistical data may include keywords for text that display certain emotional characteristics. FIG. 16, for example, illustrates a report 1600 that may be produced displaying the textual data 1602 associated with the emotion of “joy.” The report 1600 may also display the textual data associated with the emotions of “anger,” “hopeful,” and “excited” 1604, if selected.

In one embodiment, a score may be produced based upon the number of emotive data transmissions versus non-emotive data transmissions. The score may be calculated based upon multiple factors, including the frequency of emotional or non-emotional responses over a period of time, the amount of influence of the author of the emotional mention, whether there are secondary mentions (which could include a score of how much engagement an emotional or neutral item garnered, through use of retweets or comments or likes or any such parallel endorsement/sharing/engagement mechanism), or the trend of responses towards more emotional or non-emotional responses. FIG. 16, for example, illustrates a score 1606 based upon the number of emotive data transmissions versus non-emotive data transmissions processed. In one embodiment, in which a plurality of data transmissions are processed to determine a frequency of emotive versus non-emotive textual data, then the score may be produced representing the proportion of the plurality of data transmissions that are emotional relative to a total amount of the plurality of data transmissions.

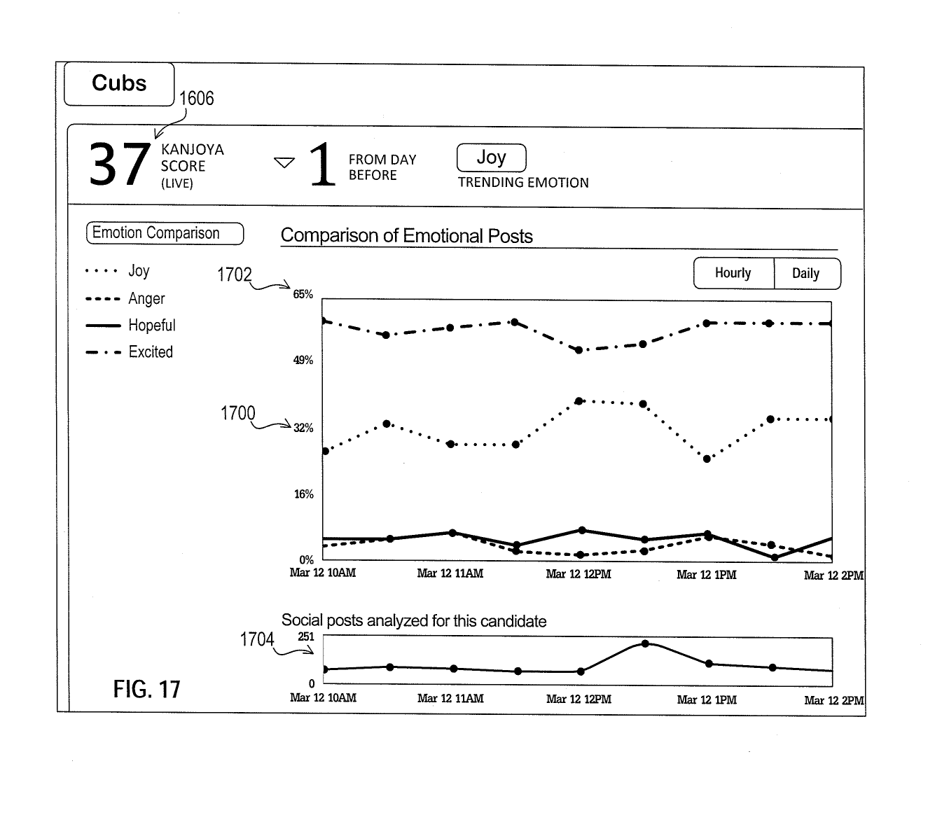

In one embodiment, a chart may be produced displaying the number of emotive or non-emotive responses over a span of time. The span of time may extend for the time an individual or group of individuals send data transmissions. Such a chart may comprise the chart 1700 shown in FIG. 17, for example. The chart may display a score value 1702, similar to the score value 1606 discussed above in regard to FIG. 16, associated with the number of emotive or non-emotive responses, or the proportion of the plurality of data transmissions that are emotional relative to a total amount of the plurality of data transmissions. The number of emotive or non-emotive responses may be displayed as a trending frequency on the chart. The chart may be filtered to only display values on the chart associated with certain emotions, or categories of emotions. Such filtering may include allowing an individual to not display a score value on the chart for a data transmission if a certain word is contained within that data transmission. Such filtering may also include allowing an individual to select an emotion or category of emotions for display on the chart. The correspondence between the multiple data transmissions and a particular grouping of emotions may be identified and displayed as desired. For example, in the embodiment shown in FIG. 16, the information on the chart 1700 may be filtered to only display information associated with the emotions of “joy,” “anger,” “hopeful,” and “excited.” The score 1702 indicates a value for the similarity between a data transmission and a certain emotion or grouping of emotions. The lines on the chart 1700 represent a line graph indicating the score value 1702. The chart may display the particular score value 1702 referenced against and/or as a function at least a portion of a span of time, and at certain times during at least a portion of the time span. The chart may also display the total number of data transmissions processed 1704 during a span of time.

In one embodiment, the chart, for example, the chart 1700 shown in FIG. 17, may be produced and/or refreshed in real time, to monitor the data transmissions in an ongoing manner.

In one embodiment, an individual may select a particular span of time to display on the chart 1700. For example, an individual may select to display a subset of a particular span of time on the chart 1700 and to not display another subset of the particular span of time on the chart 1700.

In one embodiment, a domain specific database, for example a domain specific database 804 shown in FIG. 8, may be selected based on the content of the data transmission to be processed. For example, if the data transmissions relate to sports, then the data transmissions may be compared to a domain specific database 804 related to sports, in the manner discussed in regard to FIG. 14B.

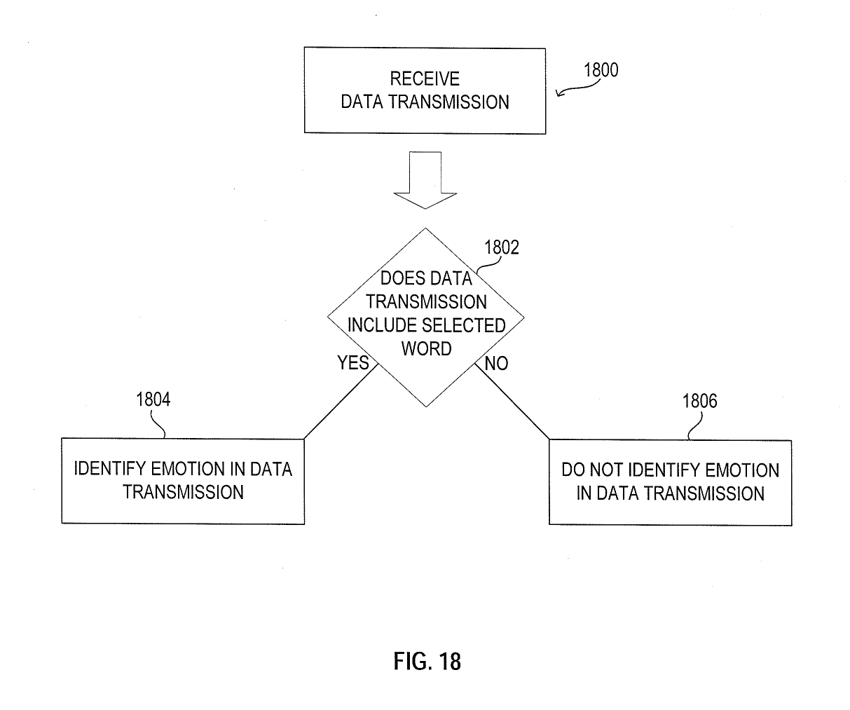

In one embodiment, the text of the data transmission may be filtered to search for certain words as desired. Only the data transmissions remaining after filtering process may be processed to determine which emotions are conveyed in the data transmissions. FIG. 18 illustrates a method of filtering the text of a data transmission. In a first step 1800, a data transmission is received in any manner discussed throughout this application. In a second step 1802, the text of the data transmission is processed to determine if the data transmission includes a selected or specified word. If so, then the emotion identification system 110 proceeds to a step 1804 of identifying emotion in the data transmission, in a manner similar to that discussed in regard to FIGS. 14A and 14B. If the word is not present in the data transmission, then the emotion identification system 110 proceeds to a step 1806 of not identifying emotion in the data transmission, similar to the process 1413 discussed in regard to FIG. 14B. For example, the filtered data transmission may be processed to determine if it is emotional or non-emotional in a manner discussed in regard to FIG. 14B. In an embodiment in which a plurality of data transmissions are received, the filtering step 1802 may be applied to the plurality of data transmissions to produce a subset of the plurality of data transmissions based on whether words of the plurality of data transmissions contain at least one specified word. The processing step 1804 is then applied to the resulting subset of the plurality of textual data. The processing step 1804 may result in any data output discussed in regard to FIGS. 15-17, including a chart displaying the particular score value 1702 referenced against and/or as a function at least a portion of a span of time, and at certain times during at least a portion of the time span.

Using the method of FIG. 18, then, for example, if a user wishes to search for data transmission postings that discuss a certain political figure, then only data transmissions using that individual's name may be examined. Every data transmission that does not include that political figure's name will not be processed to determine if it conveys certain emotions. In certain embodiments, searches may be performed for a particular commercial product or service to determine if that product or service is being discussed in the data transmission. In one embodiment, searches may be performed for the name of an individual to determine if that individual is being discussed in the data transmission.

The filtering described in relation to FIG. 18 may allow a searcher to determine if generally positive or negative emotions are being discussed about an individual, product, or service, for example. If the text of the data transmission is generally positive, then it can be assumed the emotion towards the product is generally positive. A searcher could compile the results of the filtered searches to compile information for businesses regarding whether emotions are generally positive or negative about a certain individual, product, or service. A searcher could additionally determine which particular emotions, or groupings of emotions to search for, as desired. Such searches could lead to a searcher determining if a customer is about to no longer use a product or service, how a new product that may be launched is likely to perform, or whether a purchaser is likely to desire further purchases.

In one embodiment, combinations of emotions, or classifications of emotions, may be used to search for information on whether individuals are expressing themselves emotionally. For example, there may be minimal data in a database, for example, the database 502 shown in FIGS. 11 and 13 for the emotion of “disappointed.” However, there may be more data for a grouping of emotions characterized as “surprised” and “negative.” A searcher may assume a combination of the emotions “surprised” and “negative” may result in the emotion “disappointed.” Thus, a searcher may search for a combination of emotion groupings of “surprised” and “negative” to determine if an individual is “disappointed.”

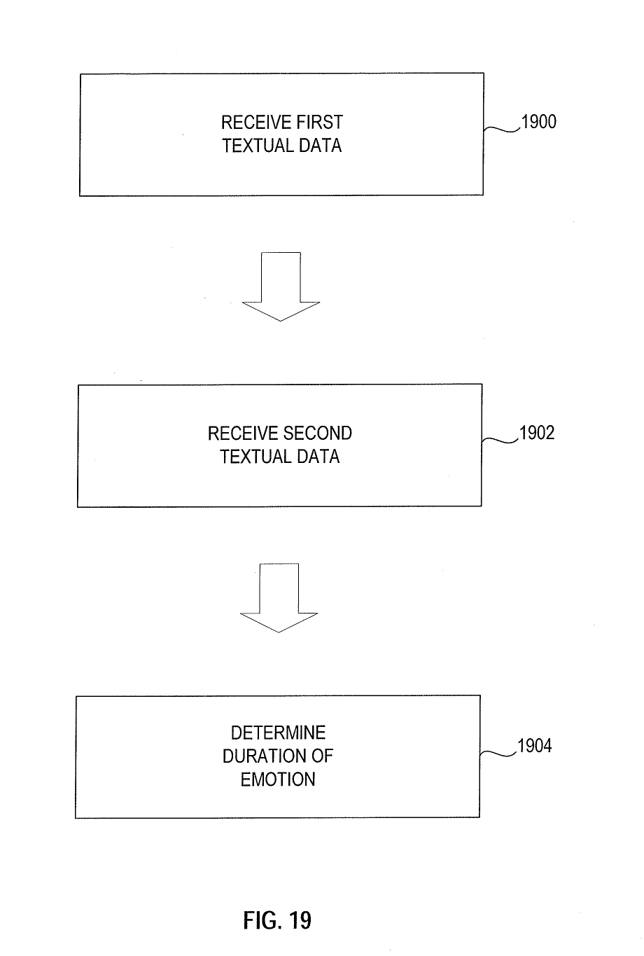

FIG. 19 illustrates an embodiment of a method performed by the emotion identification system 110 to detect the duration of emotion an individual may express. A step of the method includes receiving first textual data 1900 which is preferably received from the online forum system 108. Thus, preferably the first textual data is tagged with an emotion, in a manner discussed in regard to FIGS. 3 and 4. The time that the first textual data is received may be stored. A next step is to receive second textual data 1902 which is preferably authored by the same author as the first textual data. The second textual data is preferably received from the online forum system 108, and is also preferably tagged with an emotion, in a manner discussed in regard to FIGS. 3 and 4. The time that the second textual data is received may be stored. The second textual data may be tagged with a different emotion than the first textual data. A next step is to determine the duration 1904 that the emotional state existed for the user. The duration may be determined by calculating the difference between the time the second textual data was received and the time the first textual data was received. The duration may be stored in a database for future retrieval if desired. Once the duration is known, it may be determined whether the emotional state is a long term emotional state or a short term emotional state. In addition, each of the emotional tags produced by the author may be recorded. Thus, a duration may be associated with a particular emotion, and particular emotions may be classified as long term or short term emotional states. For example, the method shown in FIG. 19 may be used identify that “excited” is a short term emotional state and “lonely” is a long term emotional state. This information may be later applied to forecast how long another user may feel “excited,” for example. In one embodiment, a method for identifying a long term emotional state and a short term emotional state may include receiving third textual data from the author that is tagged with an emotion, in a manner discussed in regard to FIGS. 3 and 4. The third textual data is preferably tagged with a different emotion than the second textual data and the first textual data. A duration between when the third textual data and the second textual data is received may be determined. If the duration between the time the first and second textual data are received is longer than the duration between the time the second and third textual data is received, then the first textual data may be classified as being associated with a long term emotion. Also, the second textual data may be classified as being associated with a short term emotion.

In one embodiment, the emotion identification system 110 may identify which emotions are more likely to lead to other emotions at a later time, based on how often the emotions change to another emotion. For example, “gateway” emotions could be determined that lead from one general state of mind to another. The emotion of “hopeful” could generally be considered a “gateway” emotion because it likely leads to a sense of good or happy, and likely comes from a sense of sadness or depression. In one embodiment, a plurality of textual data transmissions may be received from a set of individuals, which all correspond to a single emotion. A subset of the set of individuals may then provide later textual data transmissions, the later data transmissions may correspond to different emotions. Depending on the emotion associated with the later textual data transmissions, a probability that the earlier emotion leads to a later emotion may be determined based on the total amount of data transmissions submitted, with the varied emotional states. A probability that a single emotion may lead to a later emotion may then be determined. For example, in one embodiment, a first plurality of textual data may be received that are authored by a first group of individuals. A first subset of the first group of individuals may then author a second plurality of textual data. A second subset of the first group of individuals may then author a third plurality of textual data. The first, second and third plurality of textual data may each be tagged with an emotion, in a manner discussed in regard to FIGS. 3 and 4. The tagged emotion may be different for the first, second and third plurality of textual data. Thus, the emotion identification system 110 may determine a probability that the first emotion leads to the second emotion based on the amount of the second plurality of textual data received and the amount of the third plurality of textual data received. For example, if the second and third plurality of textual data comprise all the latter textual data submitted by the first group of individuals, then the proportion of the second plurality of textual data to the sum of the second and third plurality of textual data gives a probability that the first emotion leads to the second emotion. Likewise, the emotion identification system 110 may determine a probability that the first emotion leads to the third emotion based on the proportion of the third plurality of textual data to the sum of the second and third plurality of textual data.

In one embodiment, if the first textual data 1900 or second textual data 1902 is not tagged with an emotion, then the emotion may be determined by comparing the textual data 1900, 1902 to an emotion similarity model, for example a model 1400, 1404, 1406, 1408, 1410 shown in FIG. 14B. In one embodiment, the emotion identification system 110 may analyze the first textual data 1900 and/or the second textual data 1902 to determine the language used to indicate that a user has become happy if they were previously sad. The language may indicate the certain actions a user may have taken to become happy. In one embodiment, demographic information stored regarding the user may be utilized to determine whether certain demographic groups (sex, age, geographic location, etc.) are more likely to feel certain emotions or are more likely to change emotional states more dramatically more quickly.

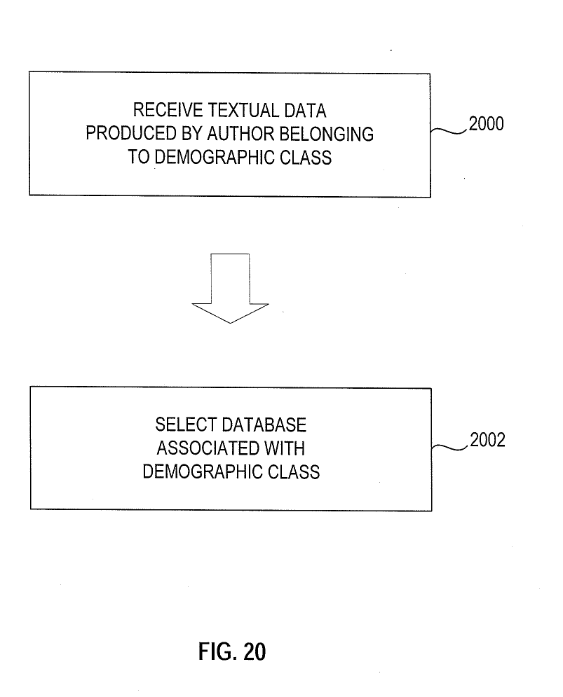

FIG. 20 illustrates an embodiment of a method performed by the emotion identification system 110 to select a database based on the demographic class of an author of textual data. The database may be associated with a demographic class of an individual or group of individuals. A step of the method includes receiving textual data produced by an author belonging to a demographic class 2000. The textual data may be authored by a user of the online forum system 108, and thus the demographic class of the author may be known because the online forum system 108 has collected that user's demographic data. A demographic class may include such information as the age of the author, the sex of the author, the geographic location of the author, the wealth or income of the author, and the like, and combinations therein. In other embodiments, the author may not be a user of the online forum system 108, yet still may have available demographic class information, for example, based on log-in information by a third party data service or other identifying information.

In a next step, a database is selected that is associated with the author's demographic class 2002. The database includes the data indicators that the author's textual data will be compared to. In this step, separate databases have been produced that each include data indicators relating to certain demographic classes. Thus, a separate database may have been produced that relates to a youthful girl profile for example. These separate databases may have been formed based on the demographic information provided by the online forum system 108. Accordingly, the author's textual data will be matched to a database and compared to the information in that database. Beneficially, this process controls for nuances in language associated with certain demographic classes.

The database may selected in a process in which a first database of data indicators that each define emotional content of textual data and are associated with a first demographic class is provided, as well as a second database of data indicators that each define emotional content of textual data and are associated with a second demographic class is provided. First textual data authored by a first individual who is associated with the first demographic class is received. Second textual data authored by a second individual who is associated with the second demographic class is received. The first and second textual data may each be tagged with at least one tag that associates at least a portion of the textual data with at least one emotion. The first and second textual data may both be processed to produce at least one data indicator defining the emotional content of the respective first or second textual data. It may then be determined whether to input the first data indicator into an emotion similarity model that uses the data indicators of the first database, or into another emotion similarity model that uses the data indicators of the second database. The first data indicator may be input into the emotion similarity model using the data indicators of the first database, in a manner similar to described in FIG. 14B, because the first data indicator is associated with the first demographic class, and the emotion similarity model is also associated with the first demographic class. The second data indicator may be input into the emotion similarity model using the data indicators of the second database, in a similar manner as described for the first data indicator. This process may be repeated as desired for any number of databases, textual data, or emotion similarity models. The process may incorporate any other method of analysis discussed in this application to produce a desired result.

In other embodiments, the method of FIG. 20 may be practiced in a manner that automatically identifies the demographic class of the author. In these embodiments, the textual data produced by an author may be compared information in multiple databases to determine which demographic class it relates to. In these embodiments, the demographic class of the author could then be determined simply by examining the textual data provided.

Benefits of the manner of producing an emotional model discussed herein include the fact that there is no need for manual training, tagging, or manipulation by the searcher. The tagging is performed by the author of the textual data used to form the database and train the models, and thus the data derives from organic expression by real users.

A benefit of the score, for example, the score 1606 shown in FIGS. 16 and 17, is to provide an easily accessible measure of how much emotional communication is taking place regarding a certain subject. The score may indicate to a business, for example, how many consumers are emotionally connecting with the product or service offered by the business. More emotive data transmissions may indicate that consumers are prepared to stop using a product, or continue to use a product, or start using a product. Businesses may mine such emotional information to determine how individuals are acting in the marketplace. Any other form of graphical display of emotional content may aid an understanding of how emotion is conveyed on a larger scale.

Unless otherwise indicated, all numbers expressing quantities used in the specification and claims are to be understood as being modified in all instances by the term “about.” Accordingly, unless indicated to the contrary, the numerical parameters set forth in the specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limited in the claims using “consisting of” or “consisting essentially of” language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

The various illustrative logical blocks, units, method steps, processes, and modules described in connection with the examples disclosed herein may be implemented or performed with a processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. Any step may be performed on a remote Internet server, a computer, or on an application (“app”) stored on a mobile phone. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the examples disclosed herein may be embodied directly in hardware, in a software module executed by a processor, or in a combination of the two. Furthermore the method and/or algorithm need not be performed in the exact order described, but instead may be varied. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a wireless modem. In the alternative, the processor and the storage medium may reside as discrete components in the wireless modem. The steps of a method or algorithm described in connection with the examples disclosed herein may be embodied in a non-transitory machine readable medium if desired.

The previous description of the disclosed examples is provided to enable any person of ordinary skill in the art to make or use the disclosed methods and system. Various modifications to these examples will be readily apparent to those skilled in the art, and the principles defined herein may be applied to other examples without departing from the spirit or scope of the disclosed method and system. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A method for determining similarity between textual data and an emotion comprising:
receiving, at a processor, first textual data authored by a first individual;
receiving, at a processor, a first tag for the first textual data that is associated with at least one emotion and associates the first textual data with the at least one emotion, the first tag being set by the first individual;
allowing, with a processor, a second individual to retrieve the first textual data from an online forum system to view the first textual data;
processing, with a processor, the first textual data to produce a first data indicator defining emotional content of the first textual data;
receiving, at a processor, second textual data from the second individual;
processing, with a processor, the second textual data to produce a second data indicator defining emotional content of the second textual data; and
inputting, with a processor, the first data indicator into an emotion similarity model and the second data indicator into the emotion similarity model to determine a similarity between the second textual data and the at least one emotion associated with the first tag.

2. The method of claim 1, wherein the first textual data is authored by the first individual on the online forum system.

3. The method of claim 1, wherein the first tag is set by the first individual on the online forum system, the first tag being selected by the first individual from a list of predetermined emotions provided on the online forum system.

4. The method of claim 1, wherein the online forum system displays the list of predetermined emotions on a webpage to multiple users of the online forum system.

5. The method of claim 1, wherein the second textual data is authored by the second individual on a mobile device.

6. The method of claim 1, wherein the second individual is allowed to retrieve the first textual data from the online forum system with a web browser.

7. The method of claim 1, wherein the first data indicator is produced using textual analysis selected from a group consisting of latent semantic analysis, and positive pointwise mutual information.

8. The method of claim 1, wherein the emotion similarity model is selected from a group consisting of a support vector machine model, a naïve bayes model, and a maximum entropy model.

9. The method of claim 1, wherein the similarity is a probability that the second textual data is the at least one emotion associated with the first tag.

10. The method of claim 1, wherein the first data indicator is a word included within the first textual data.

11. The method of claim 1, wherein the step of processing the first textual data includes producing a plurality of data indicators defining emotional content of the first textual data, the plurality of data indicators defining a feature vector of the first textual data; and
the step of inputting includes inputting the feature vector into the emotion similarity model and the second data indicator into the emotion similarity model to determine the similarity between the second textual data and the at least one emotion associated with the first tag.

12. The method of claim 1, wherein the online forum system includes a forum for multiple users of the online forum system to share textual data representing emotions.

13. A method for classifying emotions as similar emotions comprising:
receiving, at a processor, first textual data;
receiving, at a processor, a first tag for the first textual data that is associated with at least one emotion and associates the first textual data with the at least one emotion of the first tag;
processing, with a processor, the first textual data to produce a first data indicator defining emotional content of the first textual data;
receiving, at a processor, second textual data;
receiving, at a processor, a second tag for the second textual data that is associated with at least one emotion and associates the second textual data with the at least one emotion of the second tag;
processing, with a processor, the second textual data to produce a second data indicator defining emotional content of the second textual data;
comparing, with a processor, the first data indicator with the second data indicator to determine a similarity between the first data indicator and the second data indicator;
determining, with a processor, whether to classify the at least one emotion of the first tag and the at least one emotion of the second tag as a similar emotion group, based on the similarity between the first data indicator and the second data indicator; and
classifying, with a processor, the at least one emotion of the first tag and the at least one emotion of the second tag as the similar emotion group.

14. The method of claim 13, wherein the first tag is applied to the first textual data by an author of the first textual data.

15. The method of claim 14, wherein the first textual data is authored by the author on a webpage of an online forum system.

16. The method of claim 15, wherein the first tag is applied to the first textual data by the author on the webpage of the online forum system.

17. The method of claim 13, wherein the similar emotion group is a first emotion group, and further comprising:
receiving, at a processor, third textual data;
receiving, at a processor, a third tag for the third textual data that is associated with at least one emotion and associates the third textual data with the at least one emotion of the third tag;
processing, with a processor, the third textual data to produce a third data indicator defining emotional content of the third textual data;
receiving, at a processor, fourth textual data;
receiving, at a processor, a fourth tag for the fourth textual data that is associated with at least one emotion and associates the fourth textual data with the at least one emotion of the fourth tag;
processing, with a processor, the fourth textual data to produce a fourth data indicator defining emotional content of the fourth textual data;
comparing, with a processor, the third data indicator with the fourth data indicator to determine a similarity between the third data indicator and the fourth data indicator;
determining, with a processor, whether to classify the at least one emotion of the third tag and the at least one emotion of the fourth tag as a similar emotion group, based on the similarity between the third data indicator and the fourth data indicator;
classifying, with a processor, the at least one emotion of the third tag and the at least one emotion of the fourth tag as a similar emotion group being a second emotion group;
comparing, with a processor, data indicators of the first emotion group with data indicators of the second emotion group to determine a similarity between the first emotion group and the second emotion group;
determining, with a processor, whether to classify the first emotion group and the second emotion group as a similar grouping of groupings of emotions, based on the similarity between the first emotion group and the second emotion group; and
classifying, with a processor, the first emotion group and the second emotion group as the similar grouping of groupings of emotions.

18. The method of claim 13, wherein the first data indicator and the second data indicator define a feature vector of the similar emotion group, and the method further comprises:
receiving, at a processor, third textual data;
receiving, at a processor, a third tag for the third textual data that is associated with at least one emotion and associates the third textual data with the at least one emotion of the third tag;
processing, with a processor, the third textual data to produce a third data indicator defining emotional content of the third textual data; and
inputting, with a processor, the feature vector into an emotion similarity model and the third data indicator into the emotion similarity model to determine a similarity between the similar emotion group and the at least one emotion associated with the third tag.

19. The method of claim 13, wherein the similarity between the first data indicator and the second data indicator is a cosine similarity.

20. The method of claim 13, wherein the step of processing the first textual data to produce the first data indicator includes filtering the first textual data and producing a term-to-document matrix of the terms contained in the first textual data.
